(19) United States
(12) Patent Application Publication
(10) Pub. No.: US 2019/0266194 A1
(43) Pub. Date: Aug. 29, 2019

(54) INFORMATION ANALYSIS SYSTEM, INFORMATION ANALYSIS METHOD, AND RECORDING MEDIUM

(71) Applicant: NEC CORPORATION, Tokyo (JP)

(72) Inventor: Masaru KAWAKITA, Tokyo (JP)

(73) Assignee: NEC Corporation, Tokyo (JP)

(21) Appl. No.: 16/309,173

(22) PCT Filed: Jun. 19, 2017
(86) PCT No.: PCT/JP2017/022441

§ 371 Date: Dec. 12, 2018

(30) Foreign Application Priority Data
Jun. 21, 2016 (JP) 2016-122848

(51) Int. Cl. G06F 16/9038; G06F 16/903; G06F 21/55; G06N 20/00

(52) U.S. Cl. CPC G06F 16/9038; G06N 20/00; G06F 21/554; G06F 16/90335

(57) ABSTRACT

An information analysis system according to the present invention includes: a memory; and at least one processor coupled to the memory. The processor performs operations. The operations includes: acquiring a search result related to search information by searching for the search information related to a search target in any one of information sources, and further acquiring the search result related to the search information from any one of the information sources again by using the acquired search result as the search information; determining usefulness of the search result based on an evaluation accepted with respect to the search result; and controlling whether to display the search result based on the usefulness related to the search result.

### TECHNICAL FIELD

The present invention relates to a technology of collecting and analyzing information related to security.

### BACKGROUND ART

Recently, security threats caused by cyberattacks providing improper instructions for information processing devices (for example, computers, and the like) have become a social problem.

When a cyberattack occurs, a security officer collects information related to the cyberattack, for example, by using information such as a name of malware (such as an improper software program) used for the attack, IP addresses of a communication source and a communication destination, and a date and time of occurrence. At this time, the security officer may further search for related information by using collected fragmentary information.

For example, the following technologies are disclosed in relation to collection and analysis of information related to security.

Patent literature (PTL) 1 discloses a technology of extracting vulnerability information from a web page collected by web crawling, and analyzing a reference relation between extracted pieces of vulnerability information. The technology disclosed in PTL 1 acquires a related web page by following a link of a web page including vulnerability information and analyzes a reference relation between the web page including the vulnerability information and another web page.

PTL 2 discloses a technology of generating evaluation information on a website being an evaluation target, by using direct information collected by directly accessing the website being the evaluation target, and information related to a security state of the website being the evaluation target, the information being acquired from an information-providing site.

### CITATION LIST

### Patent Literature

[PTL 1] Japanese Unexamined Patent Application Publication No. 2008-197877

[PTL 2] Japanese Patent No. 5580261

### SUMMARY OF INVENTION

### Technical Problem

Due to increased cyberattacks, time required for search and collection of information related to security (may be hereinafter described as “security information”) has increased. Accordingly, man-hours required for a security officer to search for and collect information has increased. Further, when all of collected information is displayed to a security officer or the like, displayed information may become enormous. In this case, it is difficult for the security officer to recognize useful information. However, the technologies disclosed in aforementioned PTL 1 and PTL 2 are technologies of collecting security information, and collected information may not necessarily be suitably provided from a security officer's viewpoint.

The present disclosure has been made in view of such circumstances. Specifically, a main object of the present disclosure is to provide an information analysis system and the like that are capable of suitably providing information collected in terms of security.

### Solution to Problem

An information analysis system according to one aspect of the present disclosure includes:

information acquisition means for acquiring, by searching for search information being information related to a search target in any one of information source out of one or more of the information sources, a search result related to the search information, and, by using the acquired search result as the search information, being possible to further acquire the search result related to the search information from any one of the information sources;

score learning means for determining usefulness of the search result, based on an evaluation accepted with respect to the search result; and

information display means for controlling whether or not to display the search result, based on the usefulness related to the search result.

An information analysis method according to one aspect of the present disclosure includes, by an information processing system:

acquiring, by searching for search information being information related to a search target in any one of information source out of one or more of the information sources, a search result related to the search information, and, by using the acquired search result as the search information, further acquiring a search result related to the search information from any one of the information sources;

determining usefulness of the search result, based on an evaluation accepted with respect to the search result; and

controlling whether or not to display the search result, based on the usefulness related to the search result.

Further, the object is also achieved by an information analysis system including the aforementioned configuration, a computer program implementing the information analysis method with a computer, and a computer-readable recording medium recording the computer program, and the like. In other words, a recording medium according one aspect of the present disclosure records an information analysis program. The information analysis program causes a computer to execute:

a process of acquiring, by searching for search information being information related to a search target in any one of information source out of one or more of the information sources, a search result related to the search information, and, by using the acquired search result as the search information, further acquiring a search result related to the search information from any one of the information sources;

a process of determining usefulness of the search result, based on an evaluation accepted with respect to the search result; and

a process of controlling whether or not to display the search result, based on the usefulness related to the search result.

### Advantageous Effects of Invention

The present disclosure can suitably provide information collected in terms of security.

### BRIEF DESCRIPTION OF DRAWINGS

FIG. 1A is a block diagram illustrating a functional configuration example of an information analysis system 100 according to a first example embodiment of the present disclosure.

FIG. 1B is a block diagram illustrating another functional configuration example of the information analysis system 100 according to the first example embodiment of the present disclosure.

FIG. 2A is a diagram illustrating a structure example of a Wand and a Wand pool, according to the first example embodiment of the present disclosure.

FIG. 2B is a diagram illustrating a specific example of a Wand according to the first example embodiment of the present disclosure.

FIG. 2C is a diagram illustrating another structure example of a Wand pool according to the first example embodiment of the present disclosure.

FIG. 3A is a flowchart illustrating an operation example of an information acquisition unit according to the first example embodiment of the present disclosure.

FIG. 3B is a flowchart illustrating another operation example of the information acquisition unit according to the first example embodiment of the present disclosure.

FIG. 4 is a flowchart illustrating an operation example of an information display unit according to the first example embodiment of the present disclosure.

FIG. 5 is a flowchart illustrating an operation example of a score learning unit according to the first example embodiment of the present disclosure.

FIG. 6 is a diagram illustrating specific examples of search words and search results.

FIG. 7 is a diagram illustrating a specific example of a display screen presented to a user.

FIG. 8 is a flowchart illustrating an operation example of an information acquisition unit in a first modified example related to the first example embodiment of the present disclosure.

FIG. 9A is a block diagram illustrating a functional configuration example of an information analysis system in a second modified example related to the first example embodiment of the present disclosure.

FIG. 9B is a block diagram illustrating another functional configuration example of the information analysis system in the second modified example related to the first example embodiment of the present disclosure.

FIG. 10 is a flowchart illustrating an operation example of a query adjustment unit in the second modified example related to the first example embodiment of the present disclosure.

FIG. 11 is a diagram illustrating an API key database in a specific example related to the first example embodiment of the present disclosure.

FIG. 12 is a diagram illustrating a rate-limiting database in the specific example related to the first example embodiment of the present disclosure.

FIG. 13 is a diagram illustrating Wands in the specific example related to the first example embodiment of the present disclosure.

FIG. 14 is a diagram illustrating a search result database in the specific example related to the first example embodiment of the present disclosure.

FIG. 15 is a diagram illustrating a score database in the specific example related to the first example embodiment of the present disclosure.

FIG. 16 is a diagram illustrating a display screen displayed to a user in the specific example related to the first example embodiment of the present disclosure.

FIG. 17A is a diagram illustrating a display screen displayed to a user in the specific example related to the first example embodiment of the present disclosure.

FIG. 17B is a diagram illustrating a display screen displayed to a user in the specific example related to the first example embodiment of the present disclosure.

FIG. 18 is a block diagram illustrating a functional configuration example of an information analysis system according to a second example embodiment of the present disclosure.

FIG. 19 is a diagram illustrating a configuration of a hardware device capable of implementing the respective example embodiments of the present disclosure.

### EXAMPLE EMBODIMENT

Prior to description of example embodiments of the present disclosure, technical considerations and the like in the present disclosure will be described in detail.

When a cyberattack or the like occurs, for example, a security officer acquires (selects) a keyword (search word) from information (for example, a name of malware, a main body of the malware, communication information) acquired in conjunction with the cyberattack in an early stage. The security officer searches for information related to the keyword in various types of information sources. The security officer selects an additional keyword from fragmentary information acquired through such a search and further searches for information by using the keyword. For example, the security officer repeats the aforementioned search processing until acquiring information required for suitable security measures. For example, the security officer extracts (selects) useful information from collected information, based on experience, and implements security measures in order to prevent an additional attack.

With increasing cyberattacks, man-hours required for a security officer to collect and analyze information increases, and also an amount of collected information increases. Accordingly, a technical consideration in the present disclosure is to provide a technology capable of efficiently executing information search processing repeated on various types of information sources, from a viewpoint of reducing man-hours required for information collection.

Information with relatively high usefulness and information with relatively low usefulness may coexist in collected information. When collected information is provided for a security officer, the security officer is required to select useful information in such information. For example, when all of collected information are displayed to the security officer through a display screen or the like, the displayed information may explosively increase, and it is considered difficult for the security officer to recognize useful information. Accordingly, a technical consideration in the present disclosure is to provide information determined to be highly useful in collected security information by, for example, reflecting a security officer's viewpoint in terms of usefulness.

On the other hand, an information analysis system to be described by using each of the following example embodiments can, for example, repeatedly search for search information related to security from various types of information sources. For example, the information analysis system can provide (display) a collected search result for (to) a security officer or the like, and accept an evaluation related to the search result. For example, the information analysis system can appropriately adjust a provision method (display method) of the search result, depending on an accepted evaluation.

By configuring the information analysis system according to the present disclosure as described above, man-hours required for information collection may be reduced. The reason is that the information analysis system can acquire a series of pieces of information related to certain search information by repeatedly executing search processing in an information source by using search information related to security and a search result of the search information. Further, by configuring the information analysis system according to the present disclosure as described above, information useful from a security officer's viewpoint may be provided. The reason is that a provision method for a search result is adjusted by reflecting an evaluation on the collected search result by the security officer.

The information analysis system according to the present disclosure will be described in detail below by using the respective example embodiments. Configurations of the information analysis systems described in the respective example embodiments below are examples, and the technical scope of the present invention is not limited to the examples. In other words, separation (for example, division by functional units) of components constituting the information analysis system according to each of the following example embodiments is an example enabling implementation of the information analysis system, and at the time of implementation of the information analysis system, various configurations are assumed without being limited to the following examples. A component constituting the information analysis system according to each of the following example embodiments may be further divided. Further, one or more components constituting the information analysis system according to each of the following example embodiments may be integrated.

Each of the information analysis system described below may be configured by using a single device (a physical or virtual device) or may be implemented by using a plurality of separate devices (physical or virtual devices). When the information analysis system is configured with a plurality of devices, the respective devices may be communicably connected by a wired or wireless communication network (communication line), or a suitable combination of both. Such a communication network may be a physical communication network or may be a virtual communication network. A hardware configuration enabling implementation of the information analysis systems described below or components thereof will be described later.

### First Example Embodiment

### Configuration

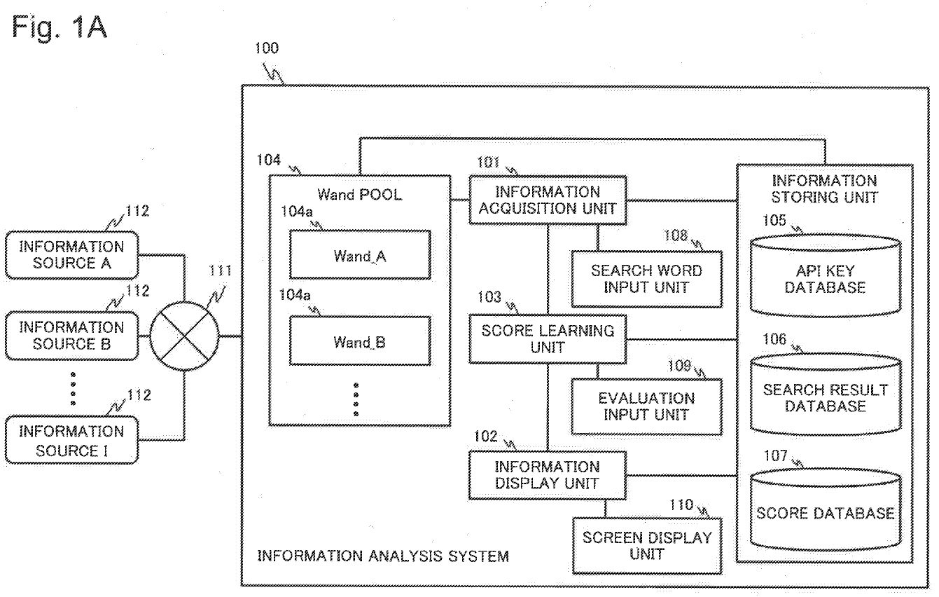

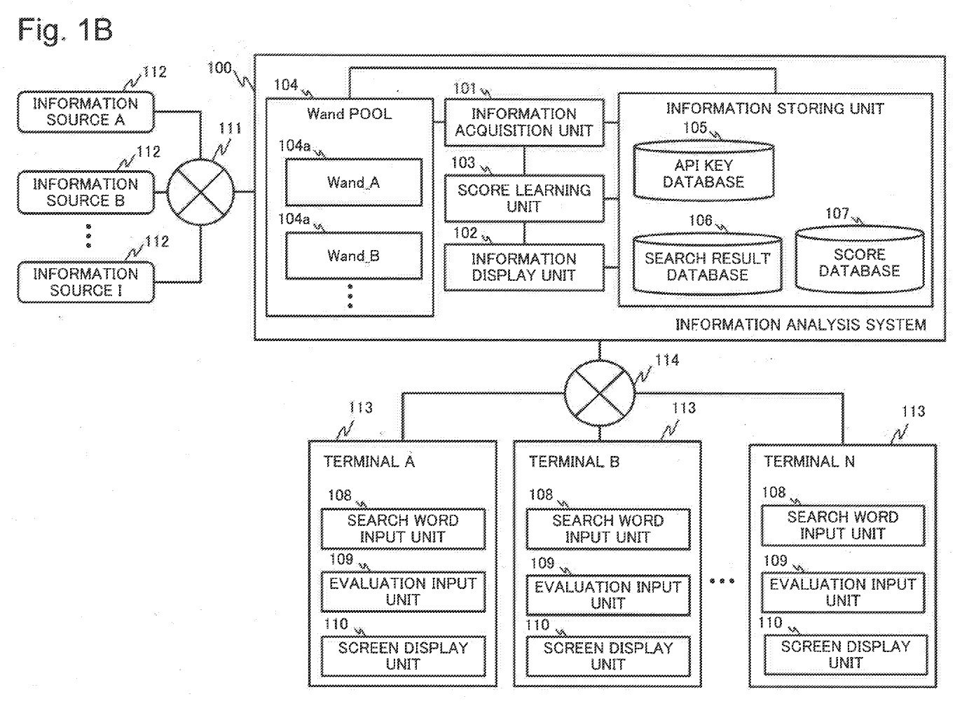

A first example embodiment related to the present disclosure will be described in detail with reference to drawings. FIG. 1A is a block diagram illustrating a functional configuration of an information analysis system 100 according to the first example embodiment of the present disclosure.

As illustrated in FIG. 1A, the information analysis system 100 includes an information acquisition unit 101, an information display unit 102, and a score learning unit 103. The information analysis system 100 may include a Wand pool 104 storing one or more Wands 104a. The information analysis system 100 may include a search result database 106 and a score database 107.

The information analysis system 100 according to the present example embodiment may be communicably connected to one or more information sources 112 through a communication network 111. For example, the communication network 111 may be a wide-area communication network such as the Internet, may be an in-house communication network such as a local area network (LAN), or may be a combination of both. The communication network 111 may be implemented by using wireless communication, wired communication, or a combination of both.

An information source 112 is a device or a system capable of providing the information analysis system 100 with information stored by the information source 112, in response to a request from the information analysis system 100. For example, the information source 112 may provide the information analysis system 100 with an application programming interface (API) available through the communication network 111. A form of such an API may be appropriately determined for each of the information sources 112. For example, when the information source 112 is a web service, such an API may be an interface (for example, transmission of a request to a specific URL) used when the web service is used.

A configuration of the information source 112 according to the present example embodiment is not particularly limited. For example, the information source 112 may be implemented as a server providing various types of information. For example, the information source 112 may be a service providing various types of vulnerability information through the communication network 111. For example, the information source 112 may be a digital signage communicable through the communication network 111. For example, the information source 112 may be a web service providing information through the communication network 111. Further, for example, the information source 112 may be a social networking service (SNS) provided through the communication network 111.

Components that may be included in the information analysis system 100 will be described below.

The information acquisition unit 101 is configured to, when certain search information is provided, search the information source 112 for information related to the search information and acquire the information from the information source 112. Such search information may be information (for example, a keyword related to a security event or the like) used for a search for a certain search target (for example, a security event such as various types of cyberattacks).

For example, the search information may be provided for the information acquisition unit 101 from a user of the information analysis system 100 through a search word input unit 108.

A user of the information analysis system 100 is not particularly limited. For example, such users may include a security officer collecting and analyzing information related to security, by using the information analysis system 100, or may include another information processing system or the like which uses the information analysis system 100. A user of the information analysis system 100 may be hereinafter simply described as a “user,” and search information provided by a user may be described as “first search information.”

For example, the search word input unit 108 may be configured to provide the information acquisition unit 101 with search information input by a user by using an input device (for example, a keyboard, a mouse, a touch panel, a microphone, a camera, or the like). For example, as search information, a user inputs to the search word input unit 108 a word, a phrase, a sentence, or the like related to a certain security event. The search word input unit 108 may convert search information accepted from a user into linguistic information (for example, text information or the like) and provide the converted information for the information acquisition unit 101. Alternatively, the information acquisition unit 101 may convert search information provided through the search word input unit 108 into linguistic information. Search information expressed as linguistic information may be hereinafter described as a “search word.” Further, a search word related to first search information may be described as a “first search word.” As described above, for example, a search word is text information representing a word, a phrase, a sentence, or the like related to a security event for which a user desires to search and may include a keyword related to the security event.

For example, the information acquisition unit 101 may acquire information related to a search word from the information source 112 by using one or more Wands 104a stored in the Wand pool 104.

For example, the Wand 104a is a search processing module that can inquire (or searches) the information source 112 of (or information provided by the information source 112 for) information related to a search word and provide the result for the information acquisition unit 101. For each of the information sources 112, the Wand 104a capable of executing an inquiry to the respective information source 112 may be assigned. One of the Wand 104a may be assigned to a plurality of the information sources 112, or a plurality of the Wands 104a may be assigned to one of the information sources 112.

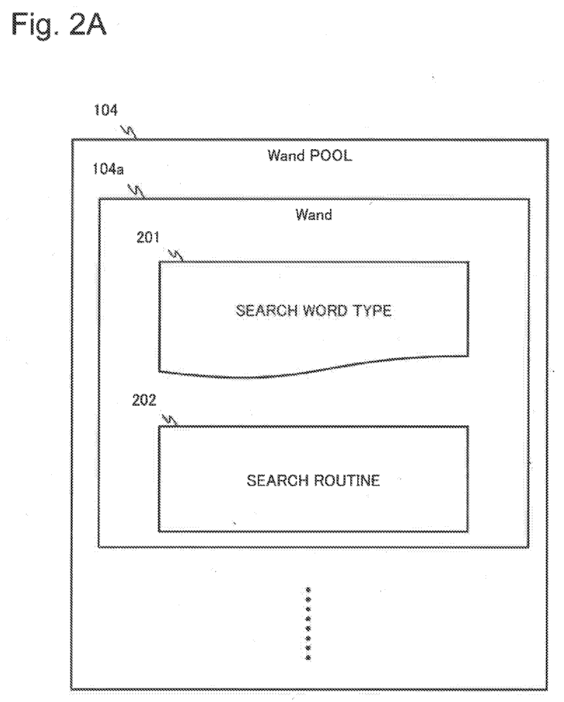

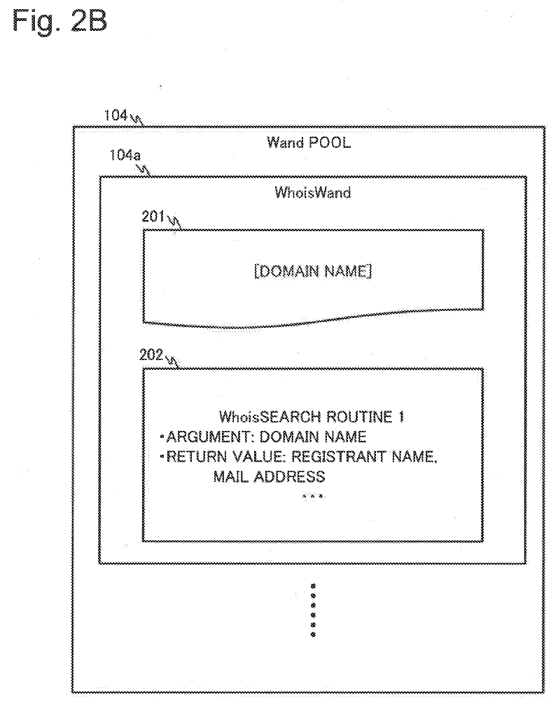

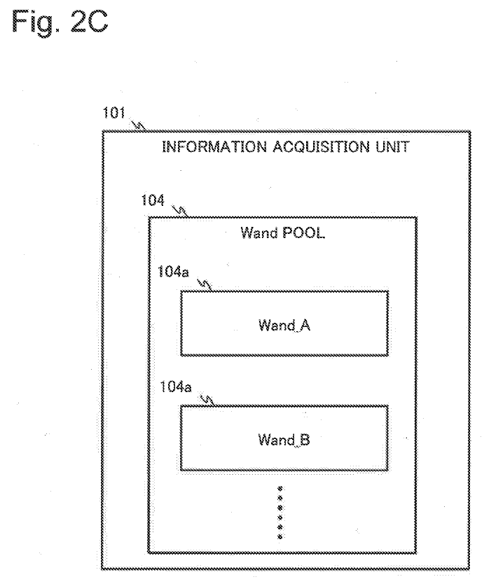

The Wand 104a will be described with reference to FIG. 2A. For example, each of the Wands 104a stores a search word type 201 as information indicating a type of search word that can be processed by the Wand 104a. For example, to such a search word type 201, a domain name, a universal resource locator (URL), a host name, an Internet Protocol (IP) address, a mail address, a personal name, a corporate name, a group name, or the like may be set as a type of search word that can be processed by the Wand 104a. For example, the search word type 201 stored by the Wand 104a may be referenceable from the information acquisition unit 101.

For example, the Wand 104a includes a search routine 202 capable of executing processing of acquiring information related to a search word from the information source 112. For example, such a search routine 202 may be configured to accept a search word provided from the information acquisition unit 101 as an argument and execute search processing on the information source 112 by using the search word. Further, such a search routine may be configured to return to the information acquisition unit 101 at least part of a search result acquired by executing such a search process, as a return value. For example, the Wand 104a may be implemented in a form of a program module or the like, or in a form of a library or the like.

For example, when executing search processing on the information source 112 providing the API, the Wand 104a may acquire from an API key database 105 (to be described later) an API key used when an API provided by the information source 112 is used.

For example, the API key is data requested when a certain API is executed (for example, data used for authentication) and is often provided (issued) by the information source 112 providing the API. When using an API requesting an API key, the Wand 104a transmits an API key to the information source 112 providing the API. For example, as a method of transmitting an API key to the information source 112, a method of setting an API key as an argument to the API is known. Note that, when using an API provided by the information source 112, whether or not an API key is required is determined depending on the information source providing the API and a type of the API, or the like. An API key can be implemented by employing a known technology, and therefore detailed description is omitted.

FIG. 2B is a diagram illustrating a specific example of the Wand 104a. In a case of the Wand 104a (WhoisWand) illustrated in FIG. 2B, a “domain name” is set to the search word type 201. Consequently, such a Wand 104a can accept a domain name as a search word. Further, a search routine using a “Whois” service as the information source 112 is set to the search routine 202 in such a Wand 104a. In other words, in the specific example illustrated in FIG. 2B, the Wand 104a searches a Whois service by using a domain name passed from the information acquisition unit 101 as an argument. Then, such a Wand 104a acquires a “registrant name,” a “mail address,” and the like as a search result, and returns the search result to the information acquisition unit 101 as a return value.

When acquiring one or more search results from the Wand 104a, the information acquisition unit 101 can provide another Wand 104a with the search results as new search words and further executes a search. In other words, the information acquisition unit 101 can repeatedly execute search processing on certain information by using a search result related to a certain search word as a new search word. When a search result related to first search information (a first search word) is used as new search information (a new search word), the new search information (search word) may be hereinafter described as second search information (a second search word). Further, when a search result related to second search information (a second search word) is used as new search information (search word), the new search information (search word) may also be described as second search information (a second search word).

The information acquisition unit 101 may register a search word and a search result provided from the Wand 104a in association with one another in the search result database 106. For example, the information acquisition unit 101 may associate a search word with a search result as a pair and register the pair in the search result database 106. When a combination of a certain search word and a search result is already registered in the search result database 106, the information acquisition unit 101 does not need to redundantly register the combination of the search word and the search result in the search result database 106.

The information acquisition unit 101 may register in the score database 107 an initial value of a score (to be described later) related to a pair of a search word and a search result. Such an initial score value may be given as a predetermined set value or may be appropriately determined by a prior experiment or the like. For example, a user may appropriately adjust such an initial score value, depending on a number of times of search results included in a screen displayed by the information display unit 102 (a screen display unit 110) to be described later, or the like.

The Wand pool 104 stores one or more of the Wands 104a. For example, the Wand pool 104 can be implemented by using a suitable data storing method such as a file system or a database. Note that, for example, when the Wand 104a is implemented in a form of a program module, the Wand pool 104 may be implemented as a package storing the module. The Wand pool 104 may be included in the information acquisition unit 101 as illustrated in FIG. 2C.

The API key database 105 may be configured to store an API key used when an API provided from the information source 112 is used. In the API key database 105, information by which an API key required for using a certain API can be identified may be appropriately registered. For example, information by which an API can be identified and an API key related to the API may be registered in association with one another in the API key database 105. Further, when an API used by each Wand 104a is predetermined, for example, information by which the Wand 104a can be identified and an API key related to an API used by the Wand 104 may be registered in association with one another. Further, for example, information by which the information source 112 providing an API can be identified and an API key may be registered in association with one another.

An API key may be preset in the API key database 105 or may be editable by a user. Alternatively, before using a certain API, the Wand 194a may acquire an API key from the information source 112 and register the API key in the API key database 105. Note that, when a search is executed solely on the information source 112 which does not request an API key (for example, when all of the information sources 112 do not require API keys), the information analysis system 100 may not include the API key database 105.

For example, in the present example embodiment, each of the Wands 104a may store an API key in place of the API key database 105.

The API key database 105 may store data by a method used in a general database (for example, a relational database or the like) or may store data by another suitable method (for example, a file and a file system, or the like).

The search result database 106 may be configured to store a search result provided from the information acquisition unit 101. For example, the search result database 106 may store a search word, a search word type indicating a type of the search word, and a search result in association with one another. The search result database 106 may store information other than the above (for example, information indicating a type of search result or the like).

The search result database 106 may store data by a method used in a general database (for example, a relational database or the like) or may store data by another suitable method (for example, a file and a file system, or the like).

The information display unit 102 is configured to control display of a search word and a search result related to the search word to a user. For example, the information display unit 102 may be configured to generate display data for displaying to a user a search word and a search result related to the search word. As an example, a mode in which the information display unit 102 generates display data to be displayed to a user and the screen display unit 110 (to be described later) displays the display data will be described below. The present example embodiment is not limited to the above, and the information display unit 102 may directly provide a user with a search result.

The information display unit 102 stores a distance from a first search word to each search result and controls display of a search word and a search result, depending on the distance and a score (to be described later) set to each search result. For example, the distance from a first search word to each search result is calculated depending on a number of times of search processing executed until each search result is acquired. Such a distance may be hereinafter described as a “first distance.”

A distance (first distance) from a first search word to each search result may be expressed by using a number of times search processing is executed until each search result is acquired. Without being limited to the above, for example, the information display unit 102 may calculate a distance from a first search word to each search result by executing addition, subtraction, multiplication, division, or the like with a suitable coefficient on a number of times of search processing executed until each search result is acquired. Alternatively, for example, the information display unit 102 may calculate a distance from a first search word to each search result by substituting a number of times search processing is executed until each search result is acquired for a suitable calculation formula.

For example, the information display unit 102 can acquire from the score database 107, to be described later, a certain search word and a score set with respect to a search result related to the search word. For example, when a score set with respect to a search result is greater than a distance (first distance) calculated with respect to the search result, the information display unit 102 may control the screen display unit 110 in such a way that the search result is displayed. In this case, the information display unit 102 may generate display data for displaying a drawing pixel visualizing relevance between the search word and the search result (for example, a line associating the search word with the search result or the like).

The information display unit 102 can generate display data for displaying an operation interface element used when a user evaluates a displayed search result. For example, such an operation interface element may be a component of graphical user interfaces (GUI) such as various types of buttons, a drop-down list, spin control, a menu, and an entry box. Such an operation interface may be an interface through which an evaluation related to a search result can be input. Further, such an operation interface may be an interface through which a display state of a search result (whether or not a search result is displayed) can be changed.

For example, when a score set with respect to a search result is less than a distance (first distance) calculated with respect to the search result, the information display unit 102 may generate display data for inhibiting display of the search result. In this case, the information display unit 102 can generate display data for displaying an operation interface element (for example, a button or the like) used when redisplaying a search result display of which is inhibited.

For example, the information display unit 102 may store information associating a search result with an operation interface element related to the search result.

For example, when a result similar to a search result related to a certain search word is already acquired (the same search results are redundantly acquired), the information display unit 102 may generate display data for inhibiting display of the search result. Herewith, the information display unit 102 can control a content to be displayed in such a way that similar search results are not redundantly displayed at a plurality of spots.

Further, when a user performs some operation on an operation interface element, the information display unit 102 can generate suitable display data depending on the operation. For example, when the operation interface element is a button, the information display unit 102 may generate suitable display data in such a way as to, when a depression operation is executed on the button, change a display content, depending on the operation. For example, the information display unit 102 may generate display data for switching a display state (display or non-display) of at least part of search results, depending on an operation on the operation interface element. Further, the information display unit 102 may generate display data for displaying one or more different operation interface elements, depending on an operation on the operation interface element. When the operation interface element is a button, for example, the information display unit 102 may generate display data for displaying one or more different buttons, depending on a depression operation on the button.

The screen display unit 110 may be configured to accept display data generated by the information display unit 102 and present (display) the display data to a user. For example, the screen display unit 110 may include a display device (for example, one of various types of monitors, a touch panel, or the like, which includes a suitable display screen) capable of displaying data to a user.

The score learning unit 103 is configured to set a score related to a search result, depending on a user evaluation related to the search result. For example, the score learning unit 103 accepts a user evaluation related to a search result displayed with respect to a certain search word, and calculates a score related to the search result, based on the evaluation.

Specifically, for example, the score learning unit 103 can accept, through an evaluation input unit 109 (to be described later), a user input to an operation interface element displayed in conjunction with a search result by the information display unit 102 (screen display unit 110). For example, the score learning unit 103 calculates a score, depending on a type of operation interface element operated by a user, a user input related to the operation interface element, and the like. For example, such a score may be calculated by using a suitable calculation formula, depending on an operation interface element type, a user input related to the operation interface element, and the like.

For example, when a user performs an operation through the operation to an operation interface element in such a way that a certain search result is displayed, the score learning unit 103 may determine that the search result is useful. For example, when a user performs an operation through the operation to an operation interface element in such a way that a certain search result is not displayed, the score learning unit 103 may determine that the search result is not useful.

The evaluation input unit 109 may be configured to accept a user input to an operation interface element displayed in conjunction with a search result by the information display unit 102 (screen display unit 110). For example, the evaluation input unit 109 may be configured to include an input device (such as a keyboard, a mouse, a touch panel [touch sensor], or a microphone) capable of accepting a user input and be capable of accepting a user input through the input device. For example, when an operation interface element displayed by the information display unit 102 (screen display unit 110) is a “button,” the evaluation input unit 109 may accept a depression operation on the button by a user.

The score learning unit 103 may register in the score database 107 a certain search word, a search result related to the search word, and a score calculated with respect to them in association with one another. A score set with respect to a pair of a search word and a search result may be hereinafter simply described as a “search result score.”

The score database 107 may be configured to store a score related to a search result provided from the score learning unit 103. For example, the score database 107 may store a certain search word, a search result related to the search word, and a score calculated with respect to them with one another. Further, the score database 107 may be able to store a score related to a pair of a search word and a search result related to the search word, which are registered in the search result database 106. The score database 107 may store information other than the above.

The score database 107 may store data by a method used in a general database (for example, a relational database or the like) and may store data by another suitable method (for example, a file and a file system, or the like).

When the information analysis system 100 is used by a plurality of users, a score registered in the score database 107 may be shared among the plurality of users. For example, a score calculated based on an evaluation of a certain user by the score learning unit 103 is registered in the score database 107. Then, for example, the score is referred to by the information display unit 102 when displaying the search result to the user or another user.

Note that the information analysis system 100 according to the present example embodiment may be configured with, for example, a functional configuration as illustrated in FIG. 1B. In FIG. 1B, one or more terminals 113 are communicably connected to the information analysis system 100 through a communication network 114.

For example, the terminal 113 may be a suitable information processing device capable of processing data communication, a data input, data display, and the like, and a shape of the terminal (for example, laptop-type, tablet type, mobile-terminal-type, or the like) is not particularly limited.

The communication network 114 may be a wide-area network such as the Internet or may be a narrow-area network such as an in-house LAN. The communication network 114 may be the same communication network as the communication network 111 or may be a different communication network.

In the configuration illustrated in FIG. 1B, the terminal 113 includes the search word input unit 108, the evaluation input unit 109, and the screen display unit 110. In this case, the search word input unit 108 in the terminal 113 may accept a search word provided from a user and transmit the search word to the information analysis system 100 (in particular, the information acquisition unit 101). Further, the evaluation input unit 109 in the terminal 113 may accept an evaluation provided from a user and transmit the evaluation to the information analysis system 100 (in particular, the score learning unit 103). Further, the information display unit 102 in the information analysis system 100 may transmit generated display data to the screen display unit 110 in the terminal 113.

The information analysis system 100 configured as described above can display a search word and a search result to one or more users and accept operations by one or more users. For example, in the information analysis system 100, the score database 107 and the search result database 106 may be shared among users. Specifically, for example, data registered in the search result database 106 through search processing executed by a certain user (for example, a “user A”) may be referred to in search processing executed by another user (for example, a “user B”). Further, a score registered in the score database 107 depending on an evaluation on a certain search result by a certain user (for example, a “user A”) may be referred to in generation of display data of the search result for another user (for example, a “user B”).

By configuring as described above, in the information analysis system 100, knowledge (evaluations) of one or more users, the knowledge being related to usefulness of a search result, can be shared among one or more users. For example, when many evaluations on a certain search result are stored, it is conceivable that many evaluations on usefulness from a user's viewpoint, the evaluations being related to the search result, are stored. In other words, the information analysis system 100 can store user knowledge related to usefulness of a search result as a score.

### Operation

An operation of the information analysis system 100 configured as described above will be specifically described below. Flowcharts illustrated in respective drawings below are specific examples, and the operation of the information analysis system 100 according to the present example embodiment is not limited to the examples. Note that an execution order of processing operations (steps) in each flowchart may be interchanged within a range that does not affect the result, and one or more processing operations (steps) may be executed in parallel.

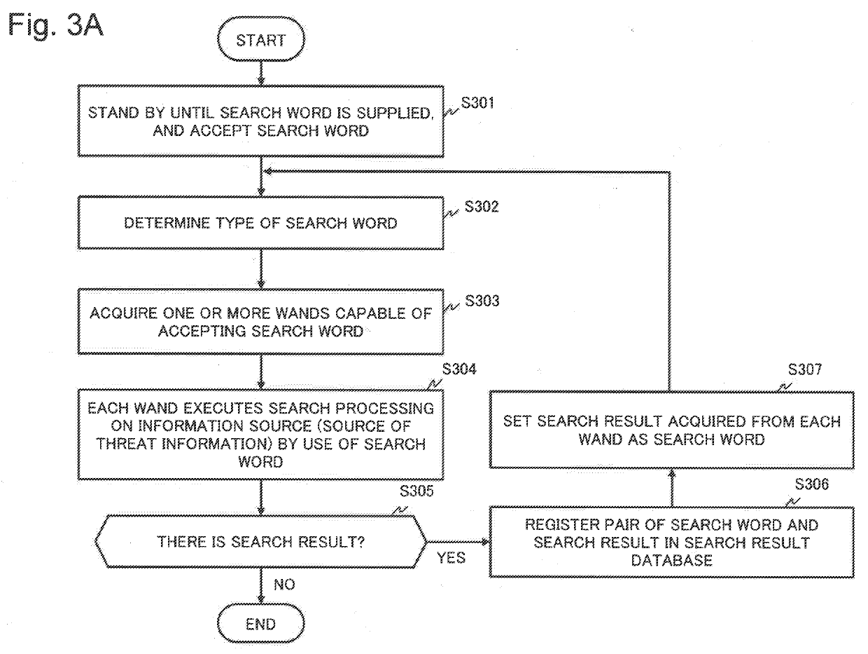

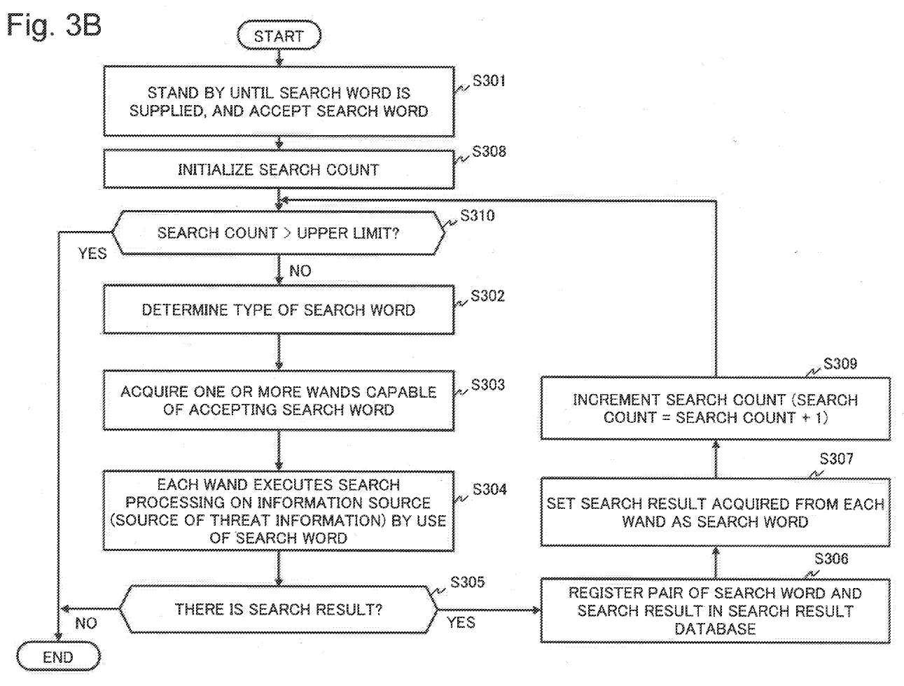

FIG. 3A is a flowchart illustrating an example of processing of acquiring information related to a certain search word from the information source 112.

For example, the information acquisition unit 101 stands by until a search word is supplied (Step S301). Specifically, the information acquisition unit 101 may stand by until a user inputs a search word through the search word input unit 108.

When a search word is supplied from the search word input unit 108, the information acquisition unit 101 determines a type of the search word (Step S302). For example, the information acquisition unit 101 may analyze text information in the search word provided from the search word input unit 108 by using a regular expression, and determine which of a URL, an IP address, a host name, a domain name, a hash value, or the like the search word relates to. The determination method of a search word type is not limited to the above, and a suitable method may be employed.

The information acquisition unit 101 acquires (selects), from the Wand pool 104, the Wand 104a capable of executing an inquiry to the information source 112, depending on the type of the search word. In this case, the Wand pool 104 may select the Wand 104a set with a search word type (201 in FIG. 2) related to the type of the search word and provide the information acquisition unit 101 with the Wand 104a. Note that, when there is no Wand 104a capable of processing the search word provided from the user, for example, the information acquisition unit 101 may display to the user a message prompting input of another search word, by using the information display unit 102.

Each of the Wands 104a selected in Step S303 acquires information related to the search word from the information source 112 (Step S304). Specifically, the Wand 104a transmits the search word to the information source 112 through the communication network 111, and receives information related to the search word as a search result. In this case, the Wand 104a may use an API provided by the information source 112. Further, when an API key for using an API provided by the information source 112 is required, the Wand 104a may acquire an API key associated with the API by referring to the API key database 105. The Wand 104a provides the search result in Step S304 for the information acquisition unit 101.

When there is a search result related to the search word searched for in Step S304 (YES in Step S305), the information acquisition unit 101 registers a pair of the search word and the search result in the search result database 106 (Step S306).

The information acquisition unit 101 newly sets the search result acquired with respect to the certain search word as a search word (Step S307) and continues the processing from Step S302. In other words, the information acquisition unit 101 repeatedly executes the search processing in the information source 112 by setting a search result related to a certain search word as a new search word.

By the processing as described above, information related to a search word provided from a user is repeatedly searched for without manual operation, and the search result is stored in the search result database 106. Accordingly, user man-hours required for an operation of acquiring information (for example, security information) related to a certain search word (for example, a keyword related to a certain security event or the like) can be reduced.

When there are a plurality of search results acquired by the Wand 104a, the information acquisition unit 101 may repeatedly execute the processing in and after Step S306 on all of the search results.

Further, when a plurality of search results are acquired in the Wand 104a, the information acquisition unit 101 may repeatedly execute the processing in and after Step S306 on part of the search results. Specifically, for example, the information acquisition unit 101 may store an upper limit of a number of times of search results as a set value or the like. When a number of times of search results acquired by the Wand 104a exceeds the upper limit of a number, for example, the information acquisition unit 101 may repeatedly execute the processing in and after Step S306 on search results within the upper limit. The information acquisition unit 101 may discontinue the processing on search results exceeding the upper limit of a number. Note that, for example, the upper limit of a number of times of search results may be appropriately set by a user or the like.

When there is not a search result related to the search word (NO in Step S305), the information acquisition unit 101 may end the processing. For example, when a suitable search result is not acquired from the information source 112 as a result of a search by the Wand 104a, the information acquisition unit 101 may determine that there is no search result. Further, for example, when a search result different from a search result already acquired with respect to a certain search word is not acquired, the information acquisition unit 101 may determine that a suitable search result is not acquired from the information source 112. In other words, when only the same search result as a search result already acquired is acquired with respect to a certain search word, the information acquisition unit 101 may determine that there is no further search result related to the search word, and end the processing.

A modified example of the processing illustrated in FIG. 3A is illustrated in FIG. 3B. In a case of such a modified example, the information acquisition unit 101 repeatedly executes search for a certain search word up to an upper limit of a search count.

Specifically, for example, when receiving a search word in Step S301, the information acquisition unit 101 initializes (for example, sets a value “0” [zero] to) a search count related to the search word (Step S308).

Further, for example, when setting a search result acquired from each Wand as a new search word in Step S307, the information acquisition unit 101 increments the search count (Step S309). In other words, the information acquisition unit 101 increments the search count when repeating the search process.

The information acquisition unit 101 compares the search count with the upper limit of the search count, and when the search count exceeds the upper limit (YES in Step S310), may end the processing. When the search count is less than or equal to the upper limit (NO in Step S310), the information acquisition unit 101 may continue the processing from Step S302. In the processing illustrated in FIG. 3B, for example, the upper limit of the search count may be previously given. Alternatively, for example, the upper limit of such a search count may be appropriately set by a user.

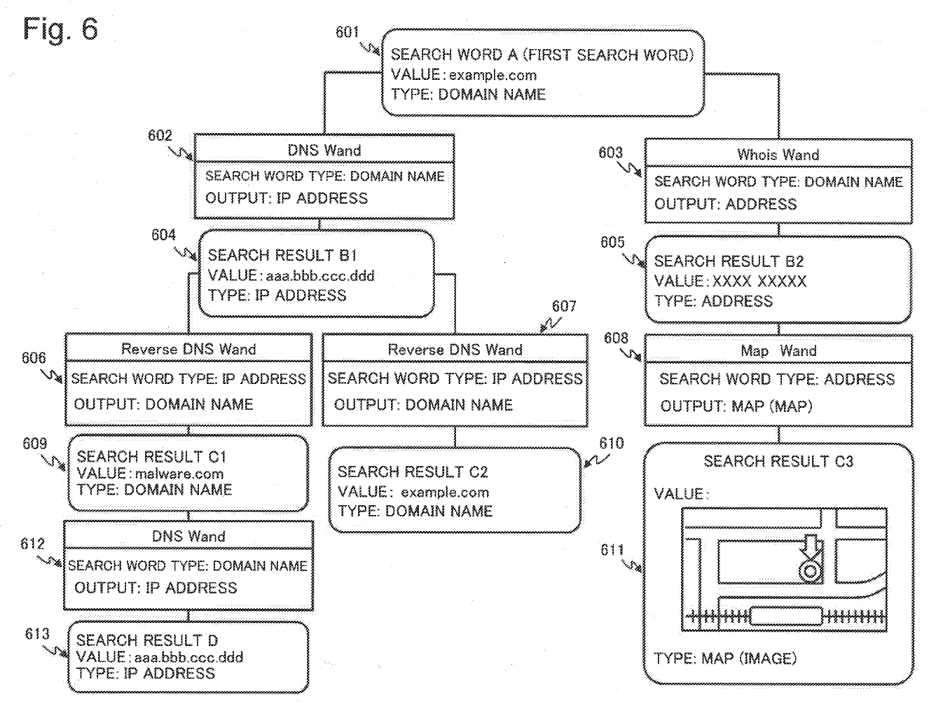

The processing illustrated in FIGS. 3A and 3B will be described by using a specific example illustrated in FIG. 6. Note that FIG. 6 is a diagram illustrating a specific example for facilitating understanding of the present example embodiment, and the present example embodiment is not limited to the specific example.

First, a search word A (a domain name “example.com” in this case: 601 in FIG. 6) is input as a first search word (Step S301). The information acquisition unit 101 determines that a type of such a search word to be a “domain name” (Step S302). It is assumed that, in the specific example in FIG. 6, a “DNS Wand” (602 in FIG. 6) and a “Whois Wand” (603 in FIG. 6) are selected as the Wands 104a capable of accepting a domain name (Step S303). The “DNS Wand” is the Wand 104a capable of acquiring information from a domain name system (DNS) as the information source 112. Further, the “Whois Wand” is the Wand 104a capable of acquiring information from a Whois service as the information source 112.

The “DNS Wand” and the “Whois Wand” execute search processing on the information sources 112 (the DNS and the Whois service), respectively, by using the search word (“example.com”) and acquire related information (Step S304). As a result of such searches, a search result B1 (an IP address “aaa.bbb.ccc.ddd”: 604 in FIG. 6) and a search result B2 (an address: 605 in FIG. 6) are acquired. In this case, a pair of the search word A and the search result B1, and a pair of the search word A and the search result B2 are registered in the search result database 106 (Steps S305 and S306).

The information acquisition unit 101 continues the processing from Step S302 with the search result B1 and the search result B2 as new search words (described as a search word B1 and a search word B2, respectively). The information acquisition unit 101 determines a type of the search result B1 (search word B1) to be an “IP address” (Step S302). It is assumed that, in the specific example in FIG. 6, a “Reverse DNS Wand” (606 and 607 in FIG. 6) is selected as the Wand 104a capable of accepting an IP address (Step S303). The “Reverse DNS Wand” is the Wand 104a capable of acquiring information from a reverse lookup service (resolving a domain name from an IP address) of the DNS as the information source 112.

The “Reverse DNS Wand” acquires information from the information source 112 (Step S304). As a result of such a search, a search result C1 (a domain name “malware.com”: 609 in FIG. 6) and a search result C2 (a domain name “example.com”: 610 in FIG. 6) are respectively acquired. In this case, a pair of the search word B1 and the search result C1, and a pair of the search word B2 and the search result C2 are registered in the search result database 106 (Steps S305 and S306).

The information acquisition unit 101 continues the processing from Step S302 with the search result C1 and the search result C2 as new search words. In this case, for example, the search processing is executed with the search result C1 as a search word, by using the “DNS Wand” (612 in FIG. 6), and a search result D (613 in FIG. 6) is acquired. Since the search result C2 and the search result D are search words or search results that are already acquired, the information acquisition unit 101 may end the search process.

The information acquisition unit 101 also executes processing similar to the above on the search result B2 and acquires a search result C3 (611 in FIG. 6). Note that, since the search result C3 is a map image, the information acquisition unit 101 may end the search processing when there is no Wand 104a capable of accepting a map image.

Through the processing illustrated in FIGS. 3A and 3B, processing of acquiring a search result related to the search word A being a first search word is repeatedly executed by using one or more of the Wands 104a, as illustrated in FIG. 6. For example, a user can acquire related information as illustrated in FIG. 6 merely by providing the search word A being the first search word. Consequently, user man-hours required for information collection can be reduced.

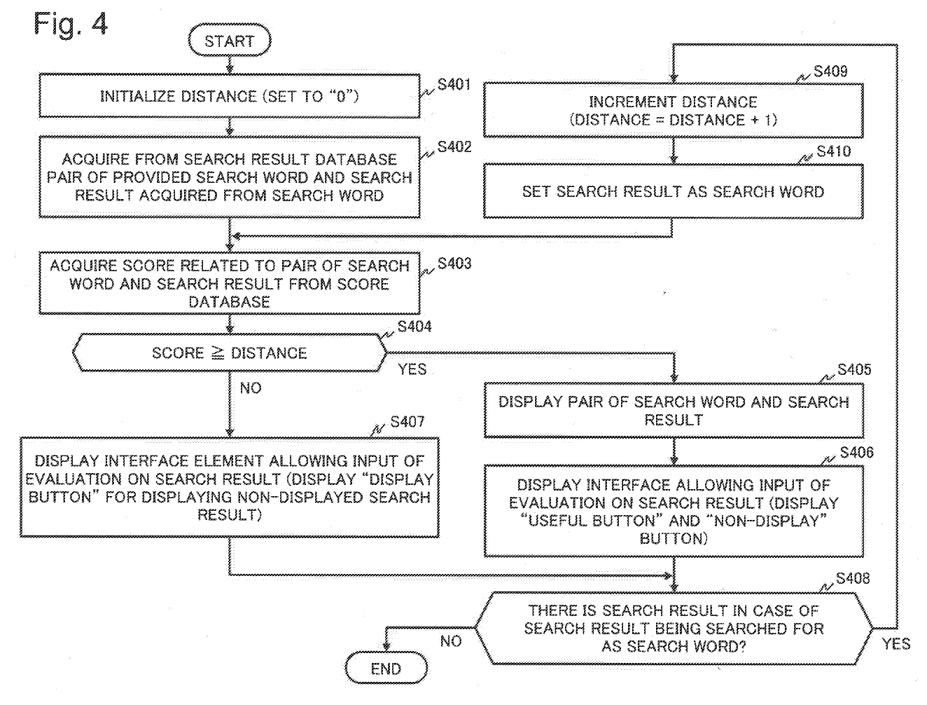

FIG. 4 is a flowchart illustrating an example of processing of displaying a search result. For example, when a search result related to a certain search word is acquired by the information acquisition unit 101, the information analysis system 100 (for example, the information display unit 102) may execute the processing illustrated in FIG. 4.

The information display unit 102 initializes a distance (first distance) from a first search word to each search result (Step S401). Specifically, the information display unit 102 may set a value “0” to such a distance (first distance).

The information display unit 102 acquires an input search word (first search word) and a search result related to the search word from the search result database 106 (Step S402). At this time, the information display unit 102 may increment a distance (first distance) between the first search word and the search result thereof to “1.” In this case, a distance (first distance) from a first search word to each search result is adjusted in such a way as to relate to an execution count of search processes.

The information display unit 102 acquires, from the score database 107, a score set with respect to a pair of the search word and the search result that are acquired in Step S402 (Step S403).

The information display unit 102 compares the distance (first distance) related to the search result with the search result score (Step S404). When the score related to the search result is greater than or equal to the distance (first distance) related to the search result (YES in Step S404), the information display unit 102 generates display data for displaying the search result (Step S405). Specifically, the information display unit 102 may generate display data including a line (for example, an arrow, a polygonal line, or the like) connecting the search word to the search result.

Further, the information display unit 102 generates display data including an operation interface element through which a user can input an evaluation related to a search result, associating the evaluation with the search result (Step S406). For example, the information display unit 102 may generate display data in which a button (“useful button”) given with a label indicating “useful” and a button (“non-display button”) given with a label indicating “non-display” are arranged close to the search result, as such operation interface elements.

On the other hand, when the score related to the search result falls below the distance (first distance) related to the search result (NO in Step S404), the information display unit 102 generates display data for inhibiting display of such a search result. The information display unit 102 may generate display data in which a button (“display button”) given with a label indicating “display” is arranged close to the search result, display of which is inhibited (Step S407).

By providing the screen display unit 110 with the display data generated as described above, the information display unit 102 can display to a user operation interface elements allowing for input of an evaluation on the search result and the search result.

The information display unit 102 checks whether or not there is a search result in a case of searching for the search result acquired in Step S402, the result being set as a search word (whether or not the search result is registered in the search result database 106) (Step S408).

In a case of YES in Step S408 (that is, when there is a search result in the case where a certain search result is set as a search word), the distance (first distance) is incremented (Step S409). Specifically, for example, the information display unit 102 adds “1” to the distance (first distance). In other words, in this case, a number of times of the search processing is executed until each of search results is acquired from the first search word relates to a distance (first distance) of the search result.

The information display unit 102 sets the search result as a new search word (Step S410), and continues the processing from Step S403.

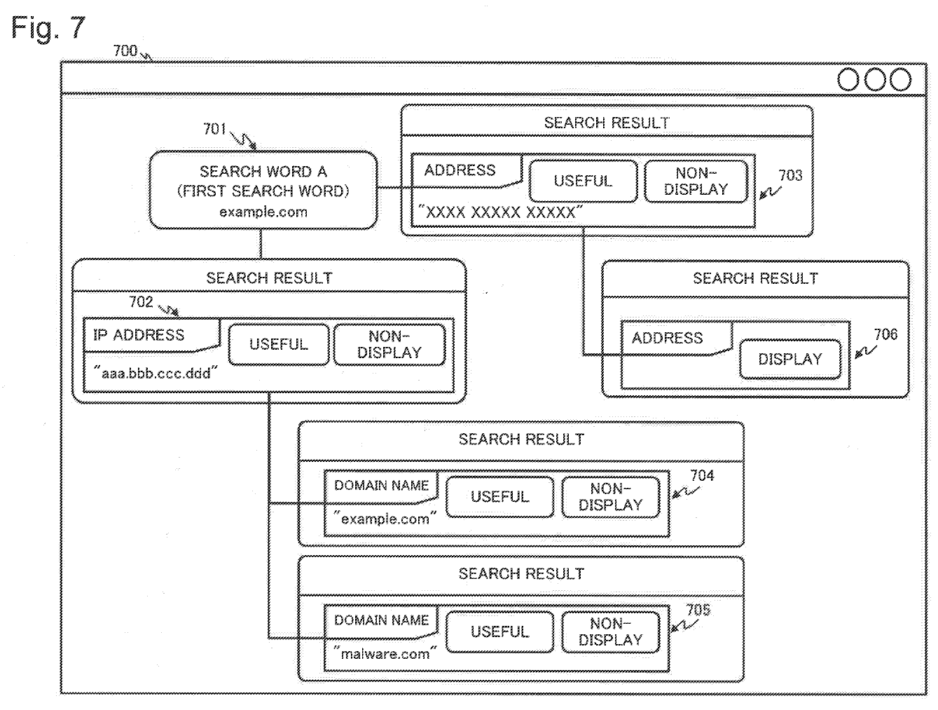

A screen displayed through the processing illustrated in FIG. 4 will be described by using a specific example illustrated in FIG. 7. For example, FIG. 7 is a diagram illustrating an example of a user interface displayed to a user through the screen display unit 110. Note that FIG. 7 is a diagram illustrating a specific example for facilitating understanding of the present example embodiment, and the present example embodiment is not limited to the specific example.

For example, a user interface 700 illustrated in FIG. 7 is a GUI displayed on the screen display unit 110. A search word A (701 in FIG. 7) being a first search word and one or more search results related to the search word (702 to 706 in FIG. 7) are displayed on the user interface 700. In the case of the specific example in FIG. 7, a line connecting the search word A (701 in FIG. 7) to a search result 702 is displayed. Further, a line connecting the search word A (701 in FIG. 7) to a search result 703 is displayed. Further, lines connecting the search result 702 to search results (search results 704 and 705) in a case of the search result 702 being set as a new search word are displayed, respectively. Further, a line connecting the search result 703 to a search result 706 in a case of the search result 703 being set as a new search word is displayed. Herewith, relevance between the search words and the search results is visualized. Further, in the specific example in FIG. 7, “useful buttons,” “non-display buttons,” and a “display button” that are related to the respective search results are displayed. By depressing such a button, a user can evaluate usefulness related to the search result and also change a display state related to the search result.

Through the processing as described above, the information display unit 102 can control whether or not to display a search result depending on a relation between a distance (first distance) related to the search result and a score. For example, through the aforementioned processing, as a distance (first distance) from an original search word (first search word) provided from a user becomes farther, a search result with a higher score may be displayed, and display of a search result with a lower score may be inhibited.

As described above, when the score database 107 is shared among a plurality of users, a score set to a certain search result, based on an evaluation by a single user, may be shared among a plurality of users. For example, when many evaluations are acquired on a certain search result, it is conceivable that knowledge related to usefulness of the search result by users are stored in a form of a score. In other words, the information display unit 102 can determine whether or not to display a certain search result, depending on user evaluations (specifically, a score calculated based on such evaluations) stored with respect to the search result. Further, it is also conceivable that display data generated by the information display unit 102 reflect user knowledge related to usefulness of each search result. Herewith, the information display unit 102 can present (display) to a user a search result determined to be highly useful from a user's viewpoint and inhibit display of a search result determined to be less useful from a user's viewpoint.

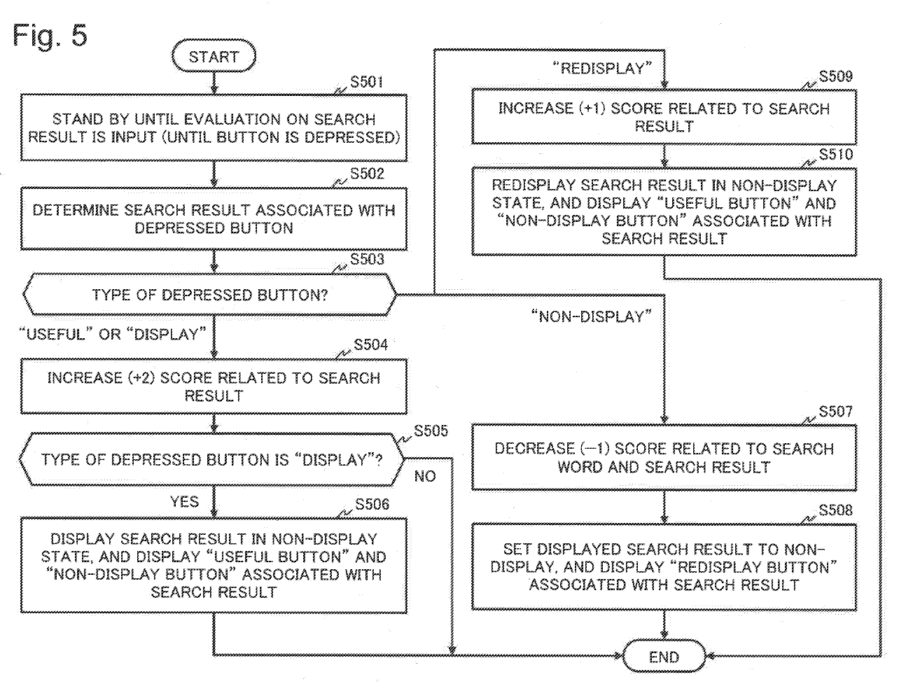

Processing of setting a score, based on a user evaluation, will be described below by using a flowchart illustrated in FIG. 5.

The score learning unit 103 stands by until a user inputs an evaluation on a search result displayed by the information display unit 102 (screen display unit 110) (Step S501). Specifically, the score learning unit 103 stands by until a user operates an operation interface element (for example, a button) displayed in conjunction with a search result. For convenience of description, it is assumed in the following description that an operation interface element displayed in conjunction with a search result is a button.

When a button is depressed by the user, the score learning unit 103 determines a search result associated with the depressed button (Step S502). Specifically, the evaluation input unit 109 may accept a depression operation on a button by the user and notify the depression operation on the button to the score learning unit 103. The score learning unit 103 may inquire a search result associated with the depressed button of the information display unit 102.

The score learning unit 103 determines a type of the depressed button (Step S503). When the type of the depressed button is a “useful button” or a “display button” (“USEFUL” or “DISPLAY” in Step S503), the score learning unit 103 increases a score of the search result for which the button is depressed (S504). Specifically, for example, the score learning unit 103 adds “2” to a score related to the search result for which the button is depressed (that is, calculated as “score=score+2”).

The score learning unit 103 may register the calculated score in the score database 107. Note that, in this case, the score learning unit 103 may increase a score of each search result existing on a route (path) leading from the first search word to the search result for which the button is depressed.

Furthermore, when the type of the depressed button is a “display button” (YES in Step S505), the search result associated with the button is displayed. In other words, the search result in a non-display state enters a display state. Further, a “useful button” and a “non-display button” are displayed as operation interface elements related to the search result (Step S506).

For example, the score learning unit 103 may request execution of the display processing in Step S506 to the information display unit 102. Alternatively, the information display unit 102 may detect a user operation and execute the display processing in Step S506 described above.

When the type of the depressed button is a “non-display button” (“NON-DISPLAY” in Step S503), the score learning unit 103 decreases a score related to the search result for which the button is depressed (Step S507). For example, the score learning unit 103 subtracts “1” from the score related to the search result for which the “non-display button” is depressed (that is, calculated as “score=score−1”). The score learning unit 103 may register the calculated score in the score database 107.

Further, when the “non-display button” is depressed, display of the search result associated with the button is inhibited. Additionally, a button given with a label “redisplay” (described as a “redisplay button”) is displayed as an operation interface related to the search result display of which is inhibited (Step S508).

For example, the score learning unit 103 may request execution of the display processing in Step S508 to the information display unit 102. Alternatively, the information display unit 102 may detect a user operation and execute the processing in Step S508 described above.

When the type of the depressed button is a “redisplay button” (“REDISPLAY” in Step S503), the score learning unit 103 increases a score related to the search result for which the button is depressed (Step S509). For example, the score learning unit 103 adds “1” to the score related to the search result for which the “redisplay button” is depressed (that is, calculated as “score=score+1”). The score learning unit 103 may register the calculated score in the score database 107. Note that, in this case, the score learning unit 103 may increase a score of each search result existing on a route (path) leading from the first search word to the search result for which the button is depressed.

Further, when the type of the depressed button is a “redisplay button,” the search result associated with the button is displayed again. Further, a “useful button” and a “non-display button” are displayed as operation interface elements related to the search result (Step S510).

For example, the score learning unit 103 may request execution of the display processing in Step S510 to the information display unit 102. Alternatively, the information display unit 102 may detect a user operation and execute the display processing in Step S510 described above.

Through the processing as described above, the score learning unit 103 can accept, through an operation on an operation interface element (for example, a button) associated with a certain search result, a user evaluation related to the search result. Then, the score learning unit 103 can calculate a score related to the search result, based on the evaluation by the user. It is conceivable that the thus calculated score reflects user knowledge related to the search result (that is, user knowledge related to usefulness of the search result).

As described above, the information display unit 102 determines whether or not to display each search result, depending on a score related to each search result and a distance (first distance) from a first search word to each search result. In other words, by using a score calculated depending on a user evaluation, the information display unit 102 can generate display data reflecting user knowledge. Through the processing as described above, a search result with a longer distance (first distance) from a user-provided first search word (with a greater search count) needs to have a higher score in order to be displayed. Herewith, display of excessive information (search result) related to a first search word on a screen can be inhibited.

For example, the information analysis system 100 according to the present example embodiment configured as described above can support a series of search operations in cyberattack analysis and reduce user man-hours. The reason is that the information acquisition unit 101 and the information display unit 102 dynamically and repeatedly collect information related to input information (a first search word) and display the information on a screen.

Further, the information analysis system 100 according to the present example embodiment can present (display) information (a search result) useful from a user's viewpoint to a user. The reason is that the score learning unit 103 calculates a score reflecting a user evaluation on a search result (that is, whether or not a certain search result is useful). Further, the information display unit 102 displays a search result determined to be highly useful and also inhibits display of a search result determined to be less useful, based on a score. Herewith, it is conceivable that information useful from a user's viewpoint in collected information (search results) is provided for a user.

Furthermore, by the information analysis system 100 according to the present example embodiment, a user can evaluate usefulness of a search result through an intuitive operation. The reason is that a score related to a search result is adjusted when a user changes a display state of the inspection result through the operation interface element (such as a “useful button,” a “non-display button,” a “display button,” and a “redisplay button”) related to the search result. For example, when a user determines that a certain search result does not need to be checked, the use can inhibit display of the search result by depressing a “non-display button” related to the search result. Then, through such an operation, a score related to the search result is decreased. Accordingly, through an intuitive operation of “inhibiting display of an unnecessary search result,” the user can evaluate usefulness of the search result at the same time.

From the above, the information analysis system according to the present example embodiment can suitably provide information collected in terms of security, from a security officer's (user's) viewpoint.

A first modified example of the present example embodiment (hereinafter described as a “modified example 1”) will be described below. A functional configuration of the information analysis system 100 in the modified example 1 may be similar to the configuration illustrated in aforementioned FIGS. 1A and 1B. In the modified example 1, processing in the information acquisition unit 101 is partially different from FIGS. 3A and 3B.

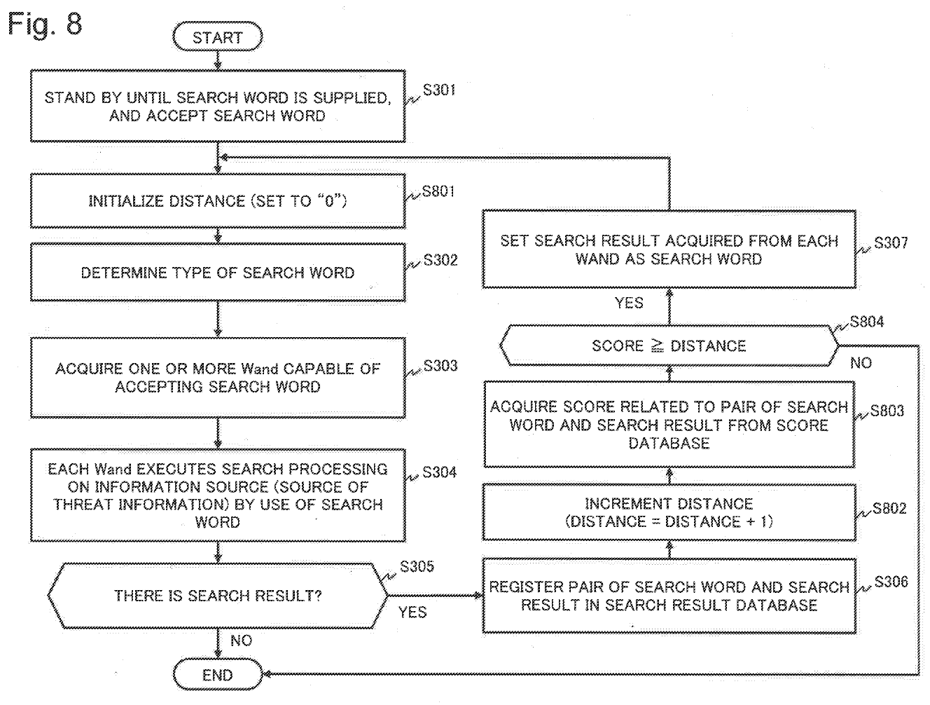

For example, the information acquisition unit 101 in the modified example 1 can determine whether or not to further continue search process, depending on a relation related to a certain search result between a distance (second distance) and a score. Such processing will be described below with reference to a flowchart illustrated in FIG. 8. Note that, out of steps illustrated in FIG. 8, a step executing processing similar to that in FIG. 3A is given a reference numeral similar to that in FIG. 3A.

The information acquisition unit 101 stands by until a search word (first search word) is input from a user, and accepts an input search word (Step S301).

The information acquisition unit 101 initializes (for example, sets “0” to) a distance (second distance) related to the accepted search word (Step S801). For example, such a distance (second distance) is a value calculated depending on a number of times of search processing executed until each search result is acquired. For example, the information acquisition unit 101 may calculate such a distance (second distance) through processing similar to Step S401 in FIG. 4 described above. In other words, a second distance and a first distance may be calculated by a similar method.

The information acquisition unit 101 determines a type of the search word (Step S302) and selects the Wand 104a capable of accepting the search word (Step S303). Then, the information acquisition unit 101 executes search processing by using the selected Wand 104a (Step S304). When there is a search result (YES in Step S305), the information acquisition unit 101 registers a pair of the search word and the search result in the search result database 106 (Step S306). Processing in Steps S302 to S306 may be similar to the processing illustrated in FIG. 3A.

The information acquisition unit 101 increments the distance (second distance) (Step S802). Specifically, the information acquisition unit 101 adds “1” to the distance (second distance). In this case, a number of times of search processing executed until each search result is acquired from the first search word relates to a distance (second distance) of the search result. At this time, the information acquisition unit 101 may execute processing similar to Step S409 in FIG. 4 described above.

The information acquisition unit 101 acquires a score related to the pair of the search word and the search result from the score database 107 (Step S803), and compares the score with the distance (second distance) (Step S804).

When the score related to the search result is greater than or equal to the distance (second distance) related to the search result, as a result of the comparison in Step S804 (YES in Step S804), the information acquisition unit 101 continues the processing from Step S307. In other words, in this case, with such a search result set as a new search word, the information acquisition unit 101 repeatedly continues the search processing using the search word.

When the score related to the search result falls below the distance (second distance) related to the search result, as a result of the comparison in Step S804 (NO in Step S804), the information acquisition unit 101 may end the search processing related to the search result. In other words, in this case, search processing with such a search result set as a new search word is not executed.

The remaining processing in the modified example 1 may be similar to the processing in the information analysis system 100 according to the present example embodiment described above.

As described above, it is conceivable that a score stores user knowledge related to usefulness of the search result. Accordingly, the information analysis system 100 in the modified example 1 configured as described above can control, depending on usefulness of a search result, whether or not to execute further search processing related to the search result. More specifically, the information acquisition unit 101 may further execute, depending on a distance (second distance) from a first search word, search processing related to a search result determined by a user to be highly useful. Further, the information acquisition unit 101 may inhibit search processing related to a search result determined by a user to be less useful.

By such a modified example 1, since search processing related to a search result determined to be less useful (that is, does not execute unnecessary search process) is not executed, processing efficiency of the information analysis system 100 is improved. Further, since search processing related to the search result determined to be less useful is not executed, the search result through the search processing is not displayed to a user. In other words, the information analysis system 100 in the modified example 1 can present (display) to a user a search result determined to be highly useful from a user's viewpoint and inhibit display of a search result determined to be less useful from a user's viewpoint.

A second modified example of the present example embodiment will be described below.

Depending on the information source 112, a number of times of inquiries (searches) per unit time may be limited for the purpose of preventing rapid increase of a processing load due to excessive inquiries, or the like. As described above, depending on the information source 112, an API key may be required when using an API provided by the information source. The information analysis system in the second modified example is configured to suitably acquire information from the information source 112 thus provided with a limitation (or a constraint) in information search.

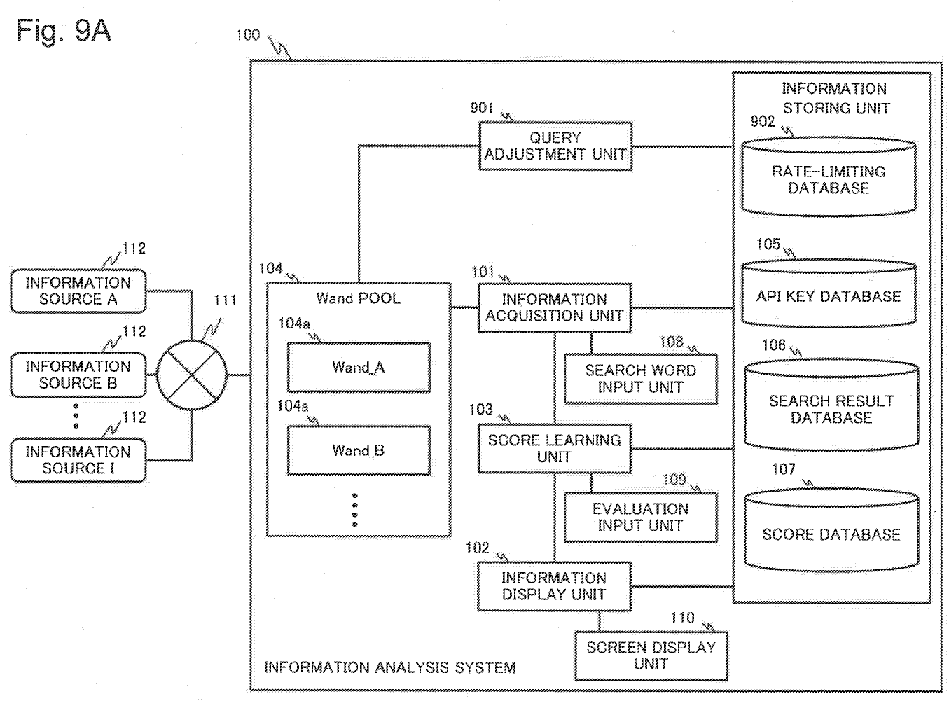

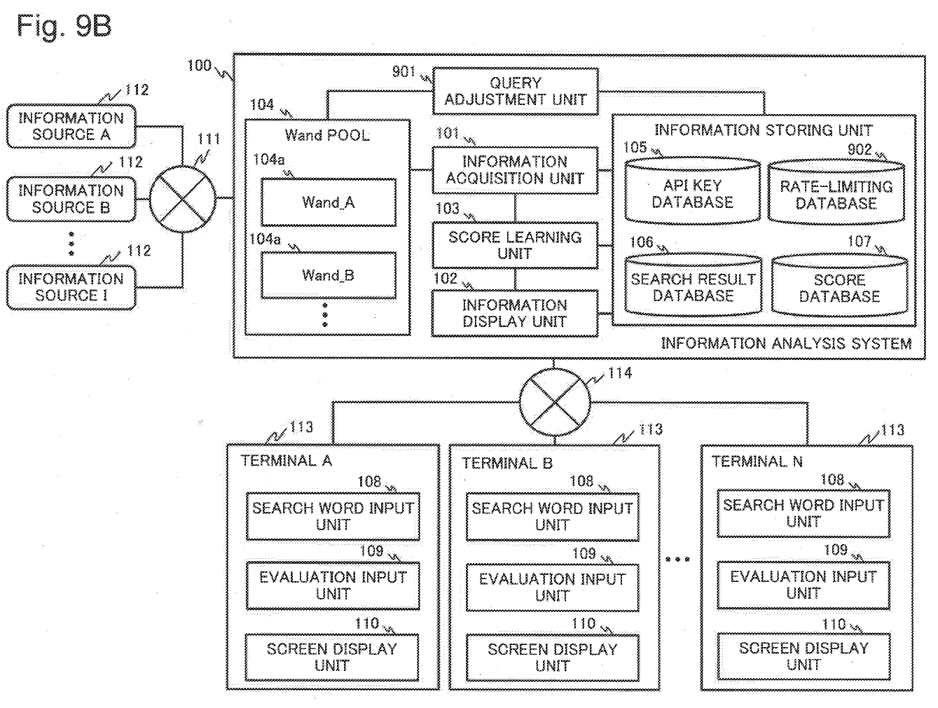

FIG. 9A is a block diagram illustrating a functional configuration of the information analysis system 100 according to the second modified example. As illustrated in FIG. 9A, the information analysis system 100 in the second modified example includes a query adjustment unit 901 and a rate-limiting database 902.

The query adjustment unit 901 adjusts whether or not search (inquiry) processing on the information source 112 can be executed. Specifically, when the Wand 104a executes a search related to the certain information source 112, the query adjustment unit 901 refers to usage history information and limiting information that are registered in the rate-limiting database 902 (to be described later). For example, the usage history information is information indicating an execution history of a search related to the information source 112. For example, the limiting information is information indicating an execution condition for a search permissible to the information source 112.

For example, the query adjustment unit 901 may calculate an execution frequency or the like of a search related to the information source 112 from the usage history information and determine whether or not the frequency or the like falls within a limit set to the limiting information. Depending on the determination result, the query adjustment unit 901 may determine whether or not search processing on the information source 112 by the Wand 104a can be executed.

The rate-limiting database 902 may be configured to store usage history information and limiting information that are related to the information source 112.

For example, the usage history information may include a time when search processing on the certain information source 112 is executed (hereinafter described as a “used time”) and an execution count of the search processing (hereinafter described as a “usage count”). For example, the used time and the usage count may be stored in association with information by which the Wand 104a executing the search processing can be identified. The used time and the usage count may be stored in association with information by which the information source 112 on which the search processing is executed can be identified.

The used time may be set with information by which a timing when the search processing is executed can be identified. For example, the used time may be set with information indicating a time. Further, the used time may be set with an elapsed time from a certain time point (for example, an elapsed time from a start of operation of the information analysis system 100). The rate-limiting database 902 may chronologically record the usage history information.

For example, the limiting information may include a time limit (time limit information) and a search count limit (search count limit information) as limiting values related to the certain information source 112. For example, the time limit and the search count limit represent that search processing up to the search count limit within the time limit is permitted in the certain information source 112. For example, such limiting information may be pre-registered in the rate-limiting database 902 or may be editable by a user or the like.

For example, information by which the certain information source 112 can be identified, the usage history information, and the limiting information may be registered in association with one another in the rate-limiting database 902. Further, for example, information by which the Wand 104a executing search processing on the certain information source 112 can be identified, the usage history information, and the limiting information may be registered in association with one another in the rate-limiting database 902.

The rate-limiting database 902 may store data by a method used in a general database (for example, a relational database or the like) or may store data by another suitable method (for example, a file and a file system, or the like).

Note that, for example, the information analysis system 100 according to the present example embodiment may be configured with a functional configuration as illustrated in FIG. 9B, similarly to FIG. 1B. A configuration of the terminal 113 in FIG. 9B is as described above.

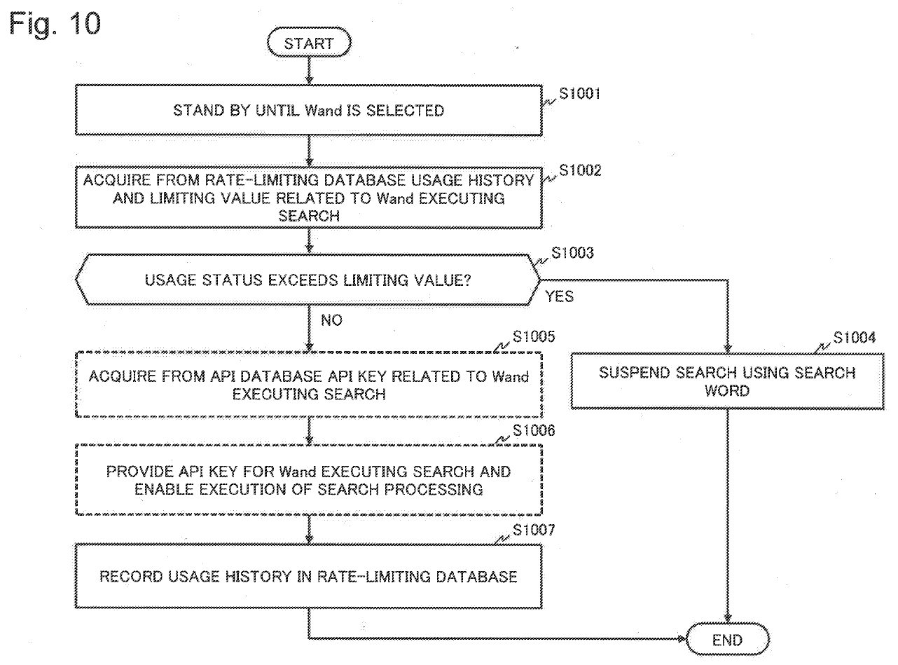

An operation of the information analysis system 100 (in particular, the query adjustment unit 901) according to this modified example will be described below with reference to a flowchart illustrated in FIG. 10.

The query adjustment unit 901 stands by until the Wand 104a is selected by the information acquisition unit 101 (Step S1001).

For example, the information acquisition unit 101 selects the Wand 104a by executing Steps S301 to S303, similarly to the flowcharts illustrated in FIGS. 3A, 3B, and 8. For example, the information acquisition unit 101 may notify the query adjustment unit 901 of selection of the Wand 104a executing a search. Alternatively, the query adjustment unit 901 may detect that the Wand 104a is selected by the information acquisition unit 101. Alternatively, the Wand 104a itself (or the Wand pool 104) selected by the information acquisition unit 101 may notify the query adjustment unit 901 of the selection of the Wand 104a.

The query adjustment unit 901 acquires from the rate-limiting database 902 the usage history information and the limiting information that are related to the Wand 104a executing a search (Step S1002).

For example, the query adjustment unit 901 may acquire the usage history information and the limiting information that are registered in the rate-limiting database 902, by using information by which the selected Wand 104a can be identified. Alternatively, for example, the query adjustment unit 901 may acquire the usage history and the limiting information that are registered in the rate-limiting database 902, by using information by which the information source 112 on which the selected Wand 104a executes search processing can be identified.

The query adjustment unit 901 determines whether or not a usage status (that is, an execution status of the search) of the information source 112 by the selected Wand 104a exceeds a limiting value set to the limiting information (Step S1003).

The query adjustment unit 901 refers to a time limit set to the limiting information. The query adjustment unit 901 checks a usage history in a period (described as a “history check period”) going back from a reference time (for example, a current time, a time when the search word is provided by a user, or the like) by the time limit. The query adjustment unit 901 counts a number of times of the executed search processing during the history check period. Specifically, for example, the query adjustment unit 901 can extract from the rate-limiting database 902 a usage history, the used time of which is included in the history check period, and count a number of times of the search processing executed during the history check period by totaling the usage counts.

When an execution count of the search processing within the time limit exceeds a search count limit as a result of the aforementioned totaling (YES in Step S1003), the query adjustment unit 901 suspends the search processing (Step S1004). The query adjustment unit 901 may notify the information acquisition unit 101 to suspend the search process. In this case, for example, the information acquisition unit 101 may suspend the processing in and after Step S304 described above (FIGS. 3A, 3B, and 8).

When the execution count of the search processing within the time limit is less than or equal to the search count limit, the query adjustment unit 901 may acquire, from the API key database 105, an API key related to an API used when executing the search (Step S1005). Note that the query adjustment unit 901 may provide the Wand 104a executing the search with the API key acquired in Step S1005 and enable execution of the search processing (Step S1006). Further, the aforementioned Wand 104a may acquire the API key without the query adjustment unit 901 executing the processing in Steps S1004 and S1005.

For example, the query adjustment unit 901 may notify the information acquisition unit 101 that the search processing can be executed. In this case, for example, the information acquisition unit 101 may continue the processing in and after Step S304 described above (FIGS. 3A, 3B, and 8).

When the execution count of the search processing within the time limit is less than or equal to the search count limit, the query adjustment unit 901 records the usage history in the rate-limiting database 902 (Step S1007). Specifically, the query adjustment unit 901 records the used time and the usage count as the usage history in the rate-limiting database 902. For example, the used time may be a current time or may be a time when the search processing is executed by the Wand 104a.

The information analysis system according to the second modified example configured as described above can suitably execute a search (inquiry) to the information source 112 within a range permitted in the information source 112. The reason is that the query adjustment unit 901 determines whether or not search processing by the Wand 104a can be executed, or the like, in consideration of a limitation (for example, an upper limit of a search count, use of an API key, or the like) provided for the certain information source 112.

From the above, the information analysis system according to the second modified example can avoid a status in which search processing on the specific information source 112 is excessively executed. In other words, the information analysis system can avoid that a user excessively executes search processing on the specific information source 112 by mistake. For example, when connection is denied by the information source 112 due to excessive execution of search processing, there is a possibility in which extra man-hours such as executing the search processing again after a while may be required. For example, the information analysis system according to the second modified example configured as described above can reduce a possibility of generation of such man-hours.

### Specific Example

An operation and the like of the information analysis system 100 according to the present example embodiment will be described below by using a specific example.

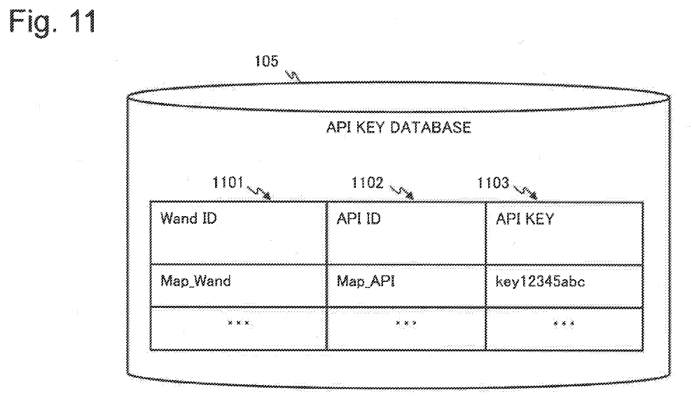

For example, it is assumed in this specific example that data as illustrated in FIG. 11 are set in the API key database 105. A Wand ID (1101 in FIG. 11) is identification information by which the Wand 104a can be identified and may be expressed by a suitable symbol, a numerical value, or the like. An API ID (1102 in FIG. 11) is identification information (ID: Identifier) by which the API used in a search can be identified and may be expressed by a suitable symbol, numerical value, or the like. The API key provided from the information source 112 is set to an API key (1103 in FIG. 11). Note that the API key database 105 may store either one of the Wand ID (1101) or the API ID (1102).

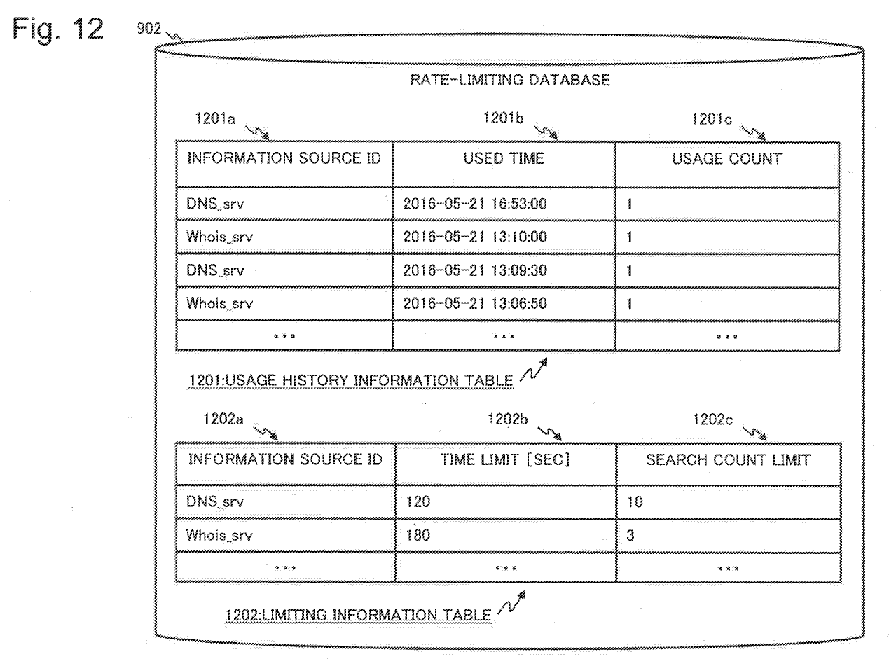

Further, it is assumed in this specific example that data as illustrated in FIG. 12 are set in the rate-limiting database 902. The usage history information is chronologically registered in a usage history information table 1201. The limiting information set to the information source 112 is registered in a limiting information table 1202.

An information source ID (1201a, 1202a in FIG. 12) is identification information by which the information source 112 can be identified and may be expressed by a suitable symbol, a numerical value, or the like. A time at which search processing related to the information source 112 identified by an information source ID is executed is registered in a used time 1201b. A number of times of search processing, which is related to the information source 112 identified by an information source ID and is executed at a time set to the used time (1201b), is registered in a usage count (1201c in FIG. 12). The time limit and the search count limit that are described in relation to the information source 112 identified by an information source ID are registered in a time limit (1202b in FIG. 12) and a search count limit (1202c in FIG. 12), respectively.

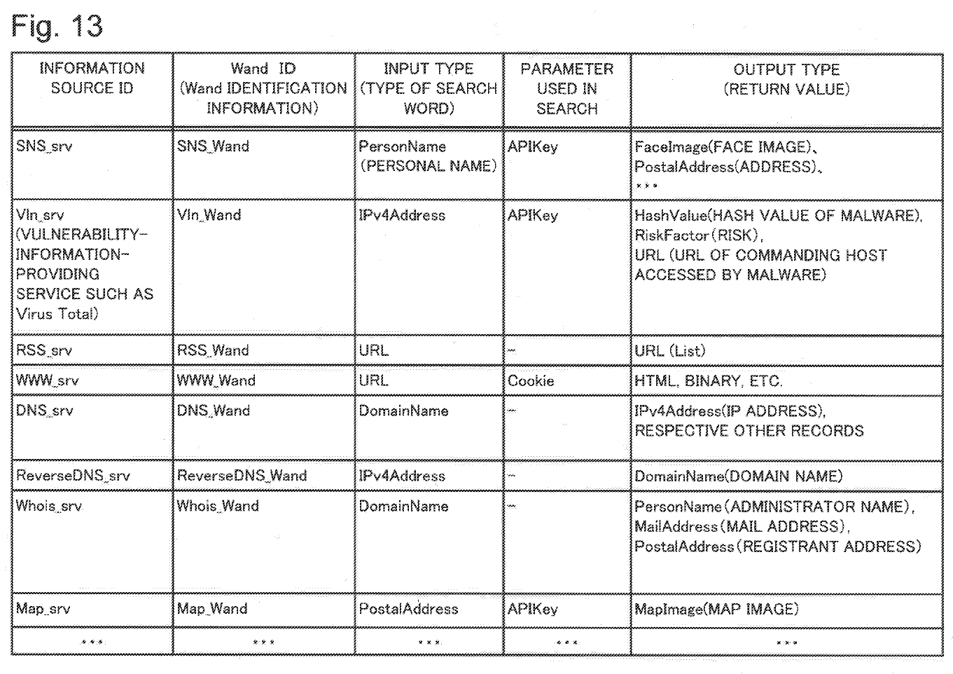

Further, it is assumed in this specific example that the Wands 104a as illustrated in FIG. 13 are available. In FIG. 13, SNS_srv is identification information (ID) of the information source 112 providing an SNS, and SNS_Wand is identification information (ID) of the Wand 104a capable of executing search processing on the information source 112. Vln_srv is identification information of the information source 112 providing a vulnerability information service, and Vln_Wand is identification information of the Wand 104a capable of executing search processing on the information source 112. RSS_srv is identification information of the information source 112 providing an RDF Site Summary or Really Simple Syndication (RSS), and RSS_Wand is identification information of the Wand 104a capable of executing search processing on the information source 112. WWW_srv is identification information of the information source 112 providing a web server in a World Wide Web (WWW), and WWW_Wand is identification information of the Wand 104a capable of executing search processing on the information source 112. DNS_srv is identification information of the information source 112 providing a DNS, and DNS_Wand is identification information of the Wand 104a capable of executing search processing on the information source 112. ReverseDNS_srv is identification information of the information source 112 providing a reverse lookup DNS, and ReverseDNS_Wand is identification information of the Wand 104a capable of executing search processing on the information source 112. Whois_srv is identification information of the information source 112 providing a Whois service, and Whois_Wand is identification information of the Wand 104a capable of executing search processing on the information source 112. Map_srv is identification information of the information source 112 providing map information, and Map_Wand is identification information of the Wand 104a capable of executing search processing on the information source 112. Note that only part of the Wands 104a illustrated in FIG. 13 may be available, or the Wand 104a not illustrated in FIG. 13 may be available.

An operation of this specific example will be described below. A user provides the search word input unit 108 with a first search word. It is assumed in this specific example that a domain name “example.com” is provided as such a first search word.

The information acquisition unit 101 acquires from the Wand pool 104 the Wand 104a capable of processing a domain name (Wand 104a in which a “domain name” is set to the search word type 201). It is assumed in this specific example that, for example, the Whois_Wand and the DNS_Wand are selected as such Wands 104a.

When the Wand 104a is selected by the information acquisition unit 101, for example, the query adjustment unit 901 acquires from the rate-limiting database 902 usage history information and limiting information that are related to the Wand 104a executing a search. In the case of this specific example, usage history information and limiting information that are related to the DNS_srv and the Whois_srv are registered in the rate-limiting database 902, as illustrated in FIG. 12.

From the limiting information and the usage history information that are related to the DNS_srv and the Whois_srv, and that are registered in the rate-limiting database 902, the query adjustment unit 901 determines whether or not search processing related to the information sources 112 can be executed. In the case of the specific example illustrated in FIG. 12, no search exceeding a search count limit within a time limit set to each information source 112 is executed. Accordingly, the query adjustment unit 901 determines that search processing related to the information sources 112 can be executed.

Further, in this specific example, API keys related to the DNS_Wand and the Whois_Wand are not set in the API key database 105, as illustrated in FIG. 11. The Whois_Wand and the DNS_Wand can execute search processing without using an API key.

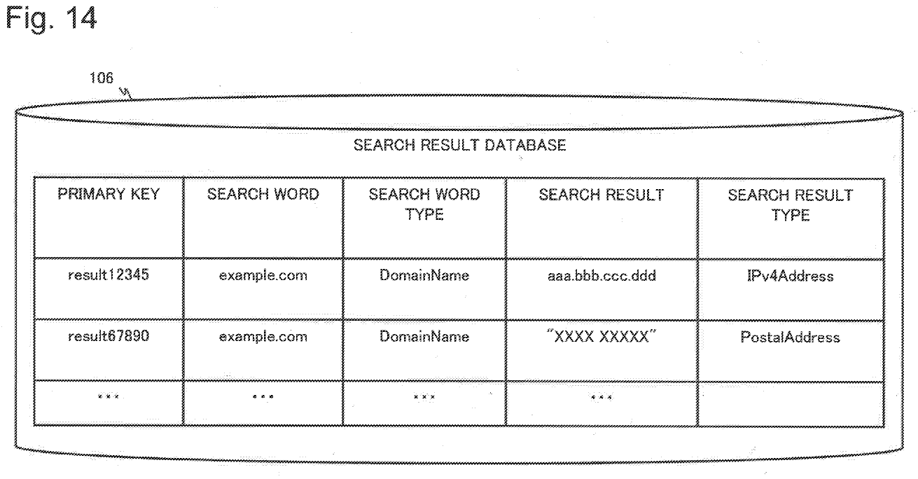

The results of the search processing executed by the Whois_Wand and the DNS_Wand are, for example, registered in the search result database 106 as illustrated in FIG. 14. It is assumed in this specific example that an IP address and an address of a registrant related to the domain are acquired as search results of the search word “example.com.” Note that information other than the above may be further registered as a search result. Note that a primary key in the search result database illustrated in FIG. 14 is identification information by which a pair of a search word and a search result can be uniquely identified.

The information display unit 102 initializes a distance (first distance) from the first search word (“example.com”) to “0” and acquires a pair of a search word and a search result from the search result database 106.

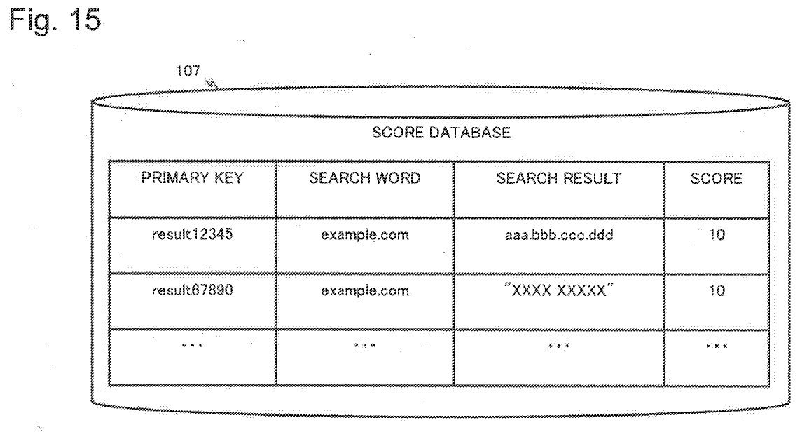

The information display unit 102 acquires a score set to the search result from the score database 107. In the case of this specific example, the information display unit 102 may acquire a primary key from the search result database 106 and acquire a score set to the search result. It is assumed in this specific example that scores as illustrated in FIG. 15 are set in the score database 107.

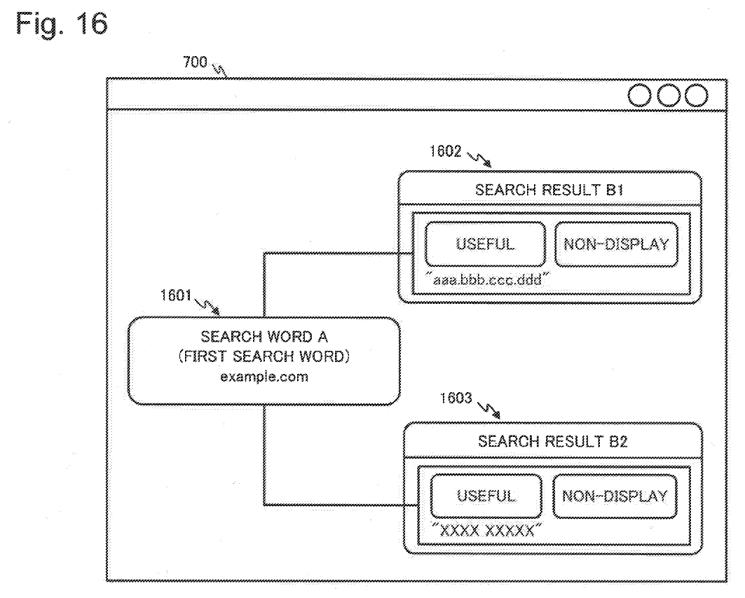

In the case of this specific example, since a distance (first distance) from the first search word to each of the search results (an IP address, and an address of a domain registrant) is less than the score, as illustrated in FIG. 15, the information display unit 102 generates display data for displaying the search results for the first search word. For example, the information display unit 102 provides the screen display unit 110 with the display data, and the screen display unit 110 displays a user interface 700 as illustrated in FIG. 16. Note that, for convenience of description, part of display elements are omitted in the user interface 700 illustrated in FIG. 16. In FIG. 16, a line connecting the search word (1601 in FIG. 16) to each of the search results (1602, and 1603 in FIG. 16) is drawn. Herewith, a relation between the search word and the search results is displayed to a user.

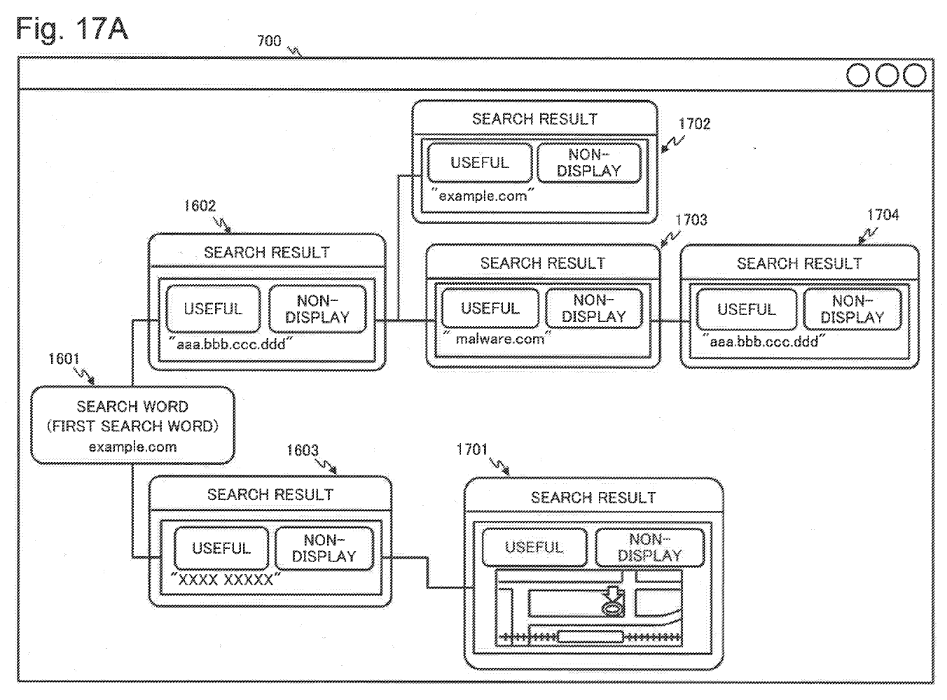

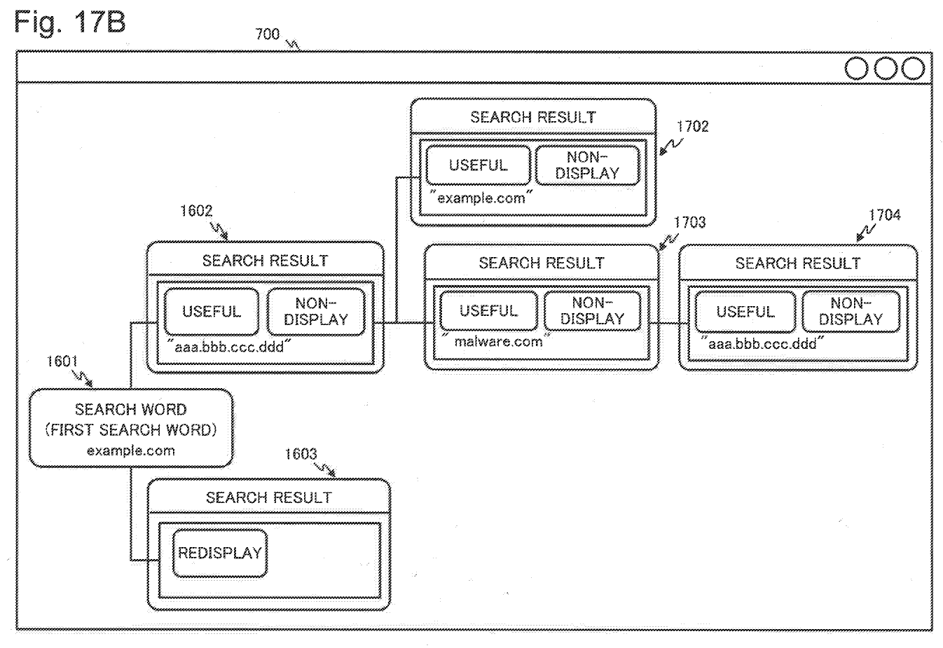

It is assumed in this specific example that, as a result of the information analysis system 100 repeatedly executing search processing with the search results illustrated in FIG. 14 as new search words, for example, a user interface 700 as illustrated in FIG. 17A is presented to a user.

In FIG. 17A, for example, a search result 1701 represents a search result (map image) related to a search word (domain registrant address), the result being acquired from the information source 112 (for example, Map_srv) by the Map_Wand. Note that the Map_Wand may execute search processing on the information source 112 (Map_srv) by using an API key registered in the API key database 105.

For example, a search result 1702 represents a search result (domain name: “example.com”) related to a search word (IP address: “aaa.bbb.ccc.ddd”), the result being acquired from the information source 112 (for example, ReverseDNS_srv) by the ReverseDNS_Wand. The same applies to a search result 1703.

For example, a search result 1704 represents a search result (IP address: “aaa.bbb.ccc.ddd”) related to a search word (domain name: “malware.com”), the result being acquired from the information source 112 (DNS_srv) by the DNS_Wand.

In the status illustrated in FIG. 17A, a case that, for example, a user depresses a “non-display” button displayed in association with the search result 1603 is assumed. In this case, the score learning unit 103 decreases a score related to the search result 1603 and registers the score in the score database 107. Further, the information display unit 102 inhibits display of the search result 1603 and the search result 1701, and a “redisplay button” is displayed on the search result 1603 (FIG. 17B).

For example, when determining that too many or unnecessary search results are displayed, a user inhibits display related to a certain search result through a button operation (depressing a “non-display button”). Further, when displaying a search result display of which is inhibited (set to non-display) again, a user displays the search result through a button operation (depressing a “redisplay button” or a “display button”). The score learning unit 103 increases or decreases a score set to a pair of a search word and a search result, depending on a depressed button, and registers the score in the score database 107. Further, when displaying the search result next time onward, the information display unit 102 determines whether or not to display the search result by referring to the registered score. Thus, the information analysis system 100 can inhibit display of excessive information (search results) on a screen, by performing control in such a way that information farther from a first search word provided by the user requires a higher score to be displayed.

### Second Example Embodiment

A second example embodiment of the present disclosure will be described below.

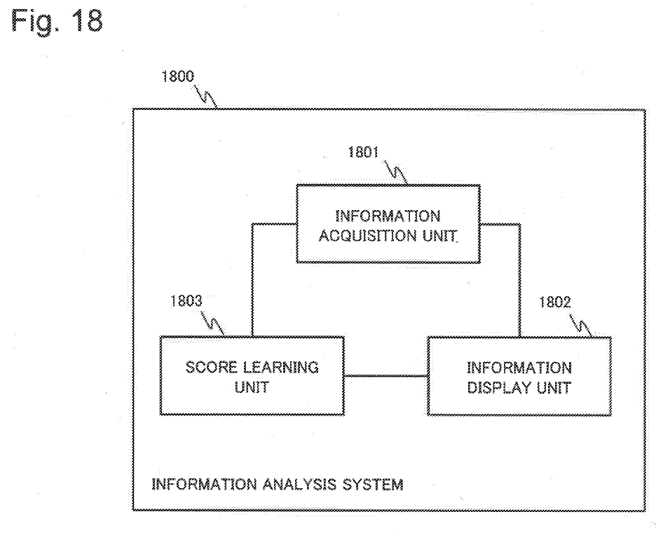

FIG. 18 is a block diagram illustrating a functional configuration of an information analysis system 1800 according to the present example embodiment. As illustrated in FIG. 18, the information analysis system 1800 includes an information acquisition unit 1801 (information acquisition means), an information display unit 1802 (information display means), and a score learning unit 1803 (score learning means). These components constituting the information analysis system 1800 may be communicably connected to one another by a suitable communication method.

Note that the information analysis system 1800 may be connected to an information source through a communication network, similarly to the information analysis system 100 according to the aforementioned first example embodiment.

The information acquisition unit 1801 is configured to execute an operation as described below. Specifically, the information acquisition unit 1801 acquires a search result of a search for search information being information related to a search target, in any one of one or more information sources. Further, by using the acquired search result as search information, the information acquisition unit 1801 executes a search for the search information in any one of one or more information sources and acquires a result of the search.

Specifically, for example, the information acquisition unit 1801 (information acquisition means) may accept search information (for example, a keyword related to a cyberattack or the like) related to a certain search target (for example, a security event such as a cyberattack) from a user of the information analysis system 1800. Then, the information acquisition unit 1801 may search for the search information accepted from the user, in an information source, and acquire a result of the search. Further, by using a search result acquired from a certain information source as new search information, the information acquisition unit 1801 may repeatedly execute a search for the information source. In other words, by repeatedly executing a search in an information source with a search result related to certain search information set as new search information, the information acquisition unit 1801 can dynamically and repeatedly acquire a search result related to the certain search information.

Note that, for example, the information acquisition unit 1801 may be configured to be able to execute processing similar to that by the information acquisition unit 101 according to the aforementioned first example embodiment.

The information display unit 1802 (information display means) is configured to execute an operation as described below. Specifically, the information display unit 1802 controls, at least partially based on a score (to be described later) related to at least a search result, whether or not to display the search result. Such a score is calculated by the score learning unit 1803.

For example, when a score related to a certain search result is greater than or equal to a specific reference (for example, a distance of a search result described in the aforementioned first example embodiment or the like), the information display unit 1802 may perform control so as to display the search result. Further, for example, when a score related to a certain search result falls below a specific reference, the information display unit 1802 may perform control so as to inhibit display of the search result. Through such processing, for example, the information display unit 1802 can determine whether or not to display respective search results repeatedly acquired by the information acquisition unit 1801, depending on scores of the respective search results. Even when there are a large number of search results acquired by the information acquisition unit 1801, the information display unit 1802 can display suitable search results to a user.

Note that, for example, the information display unit 1802 may be configured to be able to execute processing similar to that by the information display unit 102 according to the aforementioned first example embodiment.

The score learning unit 1803 is configured to execute an operation as described below. Specifically, the score learning unit 1803 accepts an evaluation related to a search result and calculates a score indicating usefulness of the search result, depending on the evaluation. For example, the score learning unit 1803 may accept an evaluation related to a search result from a user of the information analysis system 1800 through some interface. For example, when displaying a search result, the information display unit 1802 may display a user interface through which an evaluation related to the search result can be input, and the score learning unit 1803 may accept an evaluation related to the search result through a user operation on the user interface. Through such processing, for example, the score learning unit 1803 can calculate a score based on an evaluation by a user's viewpoint (that is, user knowledge) on a search result. Then, the score is used by the information display unit 1802 for determination of whether or not the search result can be displayed. In other words, through the processing as described above, it is conceivable that user knowledge on a search result is reflected in determination of whether or not to display the search result on the information display unit 1802.

Note that, for example, the score learning unit 1803 may be configured to be able to execute processing similar to that by the score learning unit 103 according to the aforementioned first example embodiment.

For example, the information analysis system 1800 according to the present example embodiment configured as described above can support a series of search operations in cyberattack analysis and reduce user man-hours. The reason is that the information acquisition unit 1801 and the information display unit 1802 dynamically and repeatedly collect information related to search information and display the information.

Further, the information analysis system 1800 according to the present example embodiment can present (display) information (a search result) useful from a user's viewpoint to a user. The reason is that the score learning unit 1803 calculates a score reflecting a user evaluation on a search result (that is, whether or not a certain search result is useful). Further, the information display unit 1802 controls whether or not to display the search result, at least partially based on the score. Herewith, information useful from a user's viewpoint in information (search results) collected by the information acquisition unit 1801 is provided for a user.

From the above, the information analysis system according to the present example embodiment can suitably provide information collected in terms of security, from a security officer's (user's) viewpoint.

### Hardware and Software Program (Computer Program) Configuration

A hardware configuration capable of implementing the respective aforementioned example embodiments will be described below.

In the following description, the information analysis systems (100, 1800) described in the respective aforementioned example embodiments are collectively and simply referred to as an “information analysis system.” Further, each component in the information analysis system is simply referred to as a “component in the information analysis system.”

The information analysis system described in each of the aforementioned example embodiments may be configured with one or a plurality of dedicated hardware devices. In that case, the respective components illustrated in the respective aforementioned drawings may be implemented as partly or wholly integrated hardware (such as an integrated circuit on which processing logic is implemented).

For example, when the information analysis system is implemented with hardware, components in the information analysis system may be implemented of integrated circuits capable of providing respective functions by a system on a chip (SoC) or the like. In this case, for example, data stored in a component in the information analysis system may be stored in a random access memory (RAM) area or a flash memory area integrated as an SoC.

Further, in this case, as a communication line connecting the respective components in the information analysis system, a known communication bus or communication network may be employed. Further, the communication line connecting the respective components may connect the respective components on a peer-to-peer. When the information analysis system is configured with a plurality of hardware devices, the respective hardware devices may be communicably connected by a suitable communication method (wired, wireless, or a combination of both).

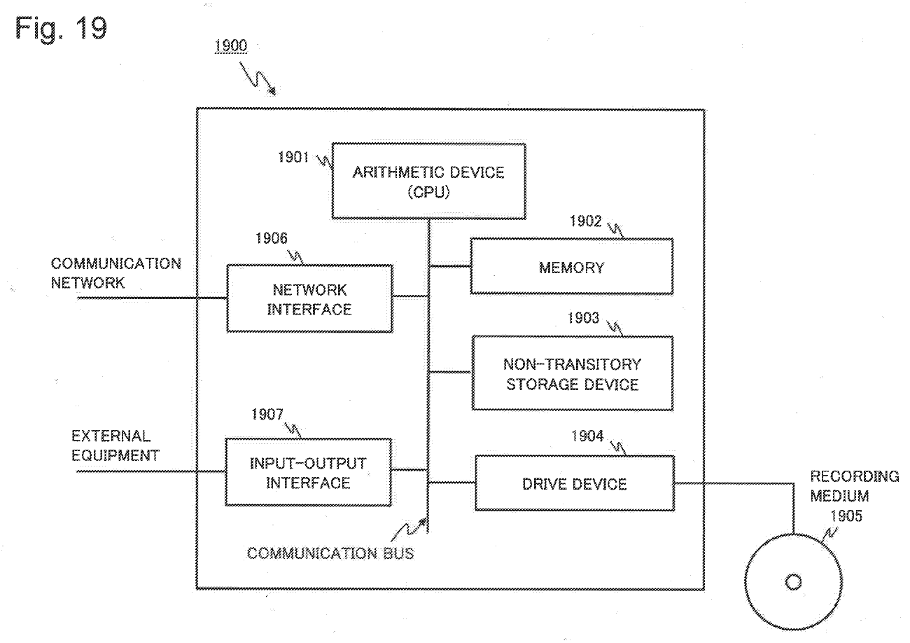

Further, the aforementioned information analysis system may be configured with a general-purpose hardware device 1900 as illustrated in FIG. 19 and various types of software programs (computer programs) executed by such a hardware device 1900. In this case, the information analysis system may be configured with a suitable number of the hardware devices 1900 and the software programs.

An arithmetic device 1901 in FIG. 19 is an arithmetic processing device such as a general-purpose central processing unit (CPU) or a microprocessor. For example, the arithmetic device 1901 may read out various types of software programs stored in a non-transitory storage device 1903, to be described later, into a memory 1902 and execute processing in accordance with such software programs. For example, a component in the information analysis system according to each of the aforementioned example embodiments can be implemented as a software program executed by the arithmetic device 1901.

The memory 1902 is a memory device, such as a RAM, being referenceable from the arithmetic device 1901, and stores a software program, various types of data, and the like. Note that the memory 1902 may be a transitory memory device.

For example, the non-transitory storage device 1903 is a non-transitory storage device such as a magnetic disk drive or a semiconductor storage device composed of a flash memory. The non-transitory storage device 1903 can store various types of software programs, data, and the like.

For example, the API key database 105, the search result database 106, the score database 107, and the rate-limiting database 902, according to the respective aforementioned example embodiments, may store data in the non-transitory storage device 1903.

For example, a drive device 1904 is a device processing reading and writing of data from and to a recording medium 1905 to be described later.

For example, the recording medium 1905 is any data-recordable recording medium such as an optical disk, a magneto-optical disk, or a semiconductor flash memory.

A network interface 1906 is an interface device connected to a communication network and may, for example, be employed an interface device for connection to wired and wireless local area networks (LAN).

For example, the hardware device 1900 implementing the information acquisition unit 101 according to each of the aforementioned example embodiments may be connected to the communication network (111, 114) through the network interface 1906. Further, the hardware device 1900 on which the Wand 104a according to each of the aforementioned example embodiments is executed may be connected to the communication network (111) through the network interface 1906.

An input-output interface 1907 is a device controlling input and output from and to an external device. For example, such an external device may be input equipment (for example, a keyboard, a mouse, or a touch panel) capable of accepting an input from a user. Further, for example, such an external device may be output equipment (for example, a monitor screen or a touch panel) capable of presenting various types of outputs to a user.

For example, the hardware device 1900 capable of implementing the information display unit (102, 1802) may display the user interface 700 described above or the like on a monitor screen connected through the input-output interface 1907. Further, for example, the hardware device 1900 capable of implementing the score learning unit (103, 1803) may accept an input (for example, an operation on an operation interface element) from a user through input equipment connected through the input-output interface 1907.

For example, the information analysis system according to the present invention described with the respective aforementioned example embodiments as examples may be implemented by supplying a software program capable of implementing the functions described in the respective aforementioned example embodiments to the hardware device 1900 illustrated in FIG. 19. More specifically, for example, the present invention may be implemented by the arithmetic device 1901 executing the software program supplied to such a device. In this case, an operating system, middleware such as a database management software or a network software, or the like that operates on the hardware device 1900 may execute part of the respective processing operations.

Each unit illustrated in the respective aforementioned drawings (for example, FIGS. 1A, 1B, 9A, 9B, and 18) in the respective aforementioned example embodiments may be implemented as a software module being a functional (processing) unit of the software program executed by the aforementioned hardware. However, separation of the respective software modules illustrated in the drawings is a configuration for convenience of description, and various configurations may be assumed at the time of implementation.

For example, when the respective aforementioned units are implemented as software modules, the software modules may be stored in the non-transitory storage device 1903. Then, when executing each processing operation, the arithmetic device 1901 may read the software modules into the memory 1902.

Further, the software modules may be configured to be capable of mutually transferring various types of data by an appropriate method such as a shared memory or inter-process communication. With such a configuration, the software modules can be communicably connected to one another.

Furthermore, the respective aforementioned software programs may be recorded in the recording medium 1905. In this case, the respective aforementioned software programs may be configured to be appropriately stored in the non-transitory storage device 1903 through the drive device 1904 in a shipping stage, an operation stage, or the like of the aforementioned communication device or the like.

Note that, in the case described above, a supply method of various types of software programs to the aforementioned information analysis system may employ a method of installation into the device by using an appropriate jig, in a manufacturing stage before shipment, a maintenance stage after shipment, or the like. Alternatively, the supply method of various types of software programs may employ a currently general procedure such as a method of downloading from outside through a communication line such as the Internet.

Then, in such a case, the present invention can be viewed to be configured with codes constituting such a software program, or a computer-readable recording medium recording such codes. In this case, such a recording medium is not limited to a medium independent of the hardware device 1900 and includes a storage medium storing or temporarily storing downloaded software programs transmitted through a LAN, the Internet, or the like.

Further, the aforementioned information analysis system or a component in the information analysis system may be configured with a virtualization environment virtualizing the hardware device 1900 illustrated in FIG. 19, and various types of software programs (computer programs) executed in the virtualization environment. In this case, a component of the hardware device 1900 illustrated in FIG. 19 is provided as a virtual device in the virtualization environment. Note that, in this case, the present invention can be implemented in a configuration similar to that in the case of configuring the hardware device 1900 illustrated in FIG. 19 as a physical device.

The present invention is described above as examples applied to the aforementioned exemplary example embodiments. However, the technical scope of the present invention is not limited to scope of the respective aforementioned example embodiments. It is obvious to a person skilled in the art that various changes or modifications can be made to such example embodiments. In other words, various modes that may be understood by a person skilled in the art may be applied to the present invention, within the scope of the present invention. In such a case, a new example embodiment with such changes or modifications may be included in the technical scope of the present invention. Furthermore, an example embodiment combining the respective aforementioned example embodiments or new example embodiments with such changes or modifications may be included in the technical scope of the present invention. This is obvious from matters described in the claims.

The whole or part of the exemplary embodiments disclosed above can be described as, but not limited to, the following supplementary notes.

(Supplementary Note 1)

An information analysis system includes:

information acquisition means for acquiring, by searching for search information being information related to a search target in any one of information source out of one or more of the information sources, a search result related to the search information, and, by using the acquired search result as the search information, being possible to further acquire the search result related to the search information from any one of the information sources;

score learning means for determining usefulness of the search result, based on an evaluation accepted with respect to the search result; and

information display means for controlling whether or not to display the search result, based on the usefulness related to the search result.

(Supplementary Note 2)

The information analysis system according to supplementary note 1, wherein

the score learning means calculates a score indicating the usefulness of the search result, based on the evaluation accepted with respect to the search result, and

the information display means controls whether or not to display the search result, based on the score related to the search result.

(Supplementary Note 3)

The information analysis system according to supplementary note 2, wherein

the information display means displays at least part of one or more of the search results, based on the score, and also displays an operation interface being a user interface used for the evaluation with respect to the search result, and

the score learning means calculates the score related to the search result, based on the evaluation with respect to the search result, the evaluation being accepted through the operation interface.

(Supplementary Note 4)

The information analysis system according to supplementary note 3, wherein

the information acquisition means
accepts first search information being the search information and acquires the search result related to the first search information in any one of the information sources, and,
by using the acquired search result as the search information, can repeatedly execute processing of further acquiring the search result related to the search information from any one of the information sources, and

the information display means
calculates a first distance between the first search information and the search result related to one of the search information, based on a number of times of searches executed in any one of the information sources during a period from execution of a search related to the first search information to acquisition of the search result related to one of the search information, and
controls whether or not to display the search result, based on the first distance related to the search result and the score related to the search result.

(Supplementary Note 5)

The information analysis system according to supplementary note 4, wherein,

when the score related to one of the search results is greater than or equal to the first distance related to the search result, the information display means displays the search result.

(Supplementary Note 6)

The information analysis system according to supplementary note 4 or 5, wherein

the operation interface is an interface allowing input of the evaluation on the usefulness related to the search result through an operation on the operation interface, and,

based on the operation on the operation interface, the score learning means increases the score related to the search result when the search result is evaluated to be useful, and decreases the score related to the search result when the search result is evaluated to be not useful.

(Supplementary Note 7)

7. The information analysis system according to any one of supplementary notes 4 to 6, wherein

the operation interface is an interface allowing an instruction to change a display state of the search result, and,

based on the operation on the operation interface, the score learning means decreases the score related to the search result when the instruction to set the displayed search result to non-display is given, and increases the score related to the search result when the instruction to display the non-displayed search result is given.

(Supplementary Note 8)

The information analysis system according to any one of supplementary notes 4 to 7, wherein

the information acquisition means
calculates a second distance between the first search information and the search result, based on a number of times of searches executed on any one of the information sources until the search result is acquired,
when the score related to one of the search results is greater than or equal to the second distance related to the search result, repeatedly executes, by using the search result as the search information, processing of acquiring the search result related to the search information from any one of the information sources out of one or more of the information sources, and,
when the score related to one of the search results is less than the second distance related to the search result, ends a search related to the search result.

(Supplementary Note 9)

The information analysis system according to any one of supplementary notes 2 to 8, further includes

query adjustment means for being possible to determine whether or not a search related to the information source can be executed, based on limiting information indicating an execution condition for the search permissible to the information source, the limiting information being set with respect to the information source, and usage history information indicating an execution history of the search in the information source, wherein

the information acquisition means
controls whether or not to acquire the search result from the information source, based on a determination result in the query adjustment means, and
updates the usage history information when acquiring the search result from the information source.

(Supplementary Note 10)

The information analysis system according to supplementary note 9, wherein

the limiting information at least includes time limit information being information indicating a period, and search count limit information being information indicating a number of times of executable searches related to the information source during the period,

the usage history information chronologically includes at least information by which a time when the search related to the information source is executed can be identified, and

the query adjustment means acquires, from the usage history information, the search executed in the information source in the period indicated by the time limit information, the period preceding a timing when the information acquisition means executes the search in the information source, and when a count of the search is less than the count indicated by the search count limit information, determines that the search related to the information source can be executed.

(Supplementary Note 11)

The information analysis system according to supplementary note 4, wherein

the score learning means stores the score calculated with respect to the search result in score storage means for being possible to store the search result and the score related to the search result, and,

when the score stored in the score storage means with respect to one of the search results is greater than or equal to the first distance related to the search result, the information display means displays the search result.

(Supplementary Note 12)

The information analysis system according to supplementary notes 2 to 11, wherein,

when one of the search results is already displayed, the information display means inhibits display of the search result identical to the search result.

(Supplementary Note 13)

An information analysis method includes, by an information processing system:

acquiring, by searching for search information being information related to a search target in any one of information source out of one or more of the information sources, a search result related to the search information, and, by using the acquired search result as the search information, further acquiring a search result related to the search information from any one of the information sources;

determining usefulness of the search result, based on an evaluation accepted with respect to the search result; and

controlling whether or not to display the search result, based on the usefulness related to the search result.

(Supplementary Note 14)

A recording medium recording an information analysis program causing a computer to execute:

a process of acquiring, by searching for search information being information related to a search target in any one of information source out of one or more of the information sources, a search result related to the search information, and, by using the acquired search result as the search information, further acquiring a search result related to the search information from any one of the information sources;

a process of determining usefulness of the search result, based on an evaluation accepted with respect to the search result; and

a process of controlling whether or not to display the search result, based on the usefulness related to the search result.

(Supplementary Note 15)

An information analysis method includes:

acquiring, by searching for search information being information related to a search target in an information source, a search result related to the search information, and, by using the acquired search result as a new search information, repeatedly executing processing of searching for the search information in the information source;

displaying at least part of the acquired search result, and an operation interface being a user interface used in an evaluation with respect to the search result;

calculating a score related to the search result, based on the evaluation with respect to the search result, the evaluation being accepted through the operation interface, and storing the calculated score in association with the search result; and,

when the search result is newly acquired, controlling whether or not to display the search result, based on a number of times of searches executed in any one of the information sources until the search result is acquired, and the score stored with respect to the search result.

(Supplementary Note 16)

The information analysis method according to supplementary note 14, further includes,

when searching for the search information in the information source, determining whether or not the search related to the information source can be executed, based on limiting information indicating an execution condition for the search permissible to the information source, the limiting information being set with respect to the information source, and usage history information indicating an execution history of the search in the information source.

This application is based upon and claims the benefit of priority from Japanese patent application No. 2016-122848, filed on Jun. 21, 2016, the disclosure of which is incorporated herein in its entirety by reference.

### REFERENCE SIGNS LIST

100 Information analysis system
101 Information acquisition unit
102 Information display unit
103 Score learning unit
104 Wand pool
104a Wand
105 API key database
106 Search result database
107 Score database
108 Search word input unit
109 Evaluation input unit
110 Screen display unit
111 Communication network
112 Information source
113 Terminal
114 Communication network
901 Query adjustment unit
902 Rate-limiting database
1800 Information analysis system
1801 Information acquisition unit
1802 Information display unit
1803 Score learning unit
1901 Arithmetic device
1902 Memory
1903 Non-transitory storage device
1904 Drive device
1905 Recording medium
1906 Network interface
1907 Input-output interface

What is claimed is:

1. An information analysis system comprising:
a memory; and
at least one processor coupled to the memory,
the processor performing operations, the operations comprising:
acquiring, by searching for search information related to a search target in any one of information sources, a search result related to the search information, and, by using the acquired search result as the search information, further acquiring the search result related to the search information from any one of the information sources again;
determining usefulness of the search result, based on an evaluation accepted with respect to the search result; and
controlling whether to display the search result, based on the usefulness related to the search result.

2. The information analysis system according to claim 1, wherein
the operations further comprises
calculating a score indicating the usefulness of the search result, based on the evaluation accepted with respect to the search result, and
controlling whether to display the search result, based on the score related to the search result.

3. The information analysis system according to claim 2, wherein
the operations further comprises
displaying at least part of one or more of the search results, based on the score, and an operation interface being a user interface used for the evaluation with respect to the search result, and
calculating the score related to the search result, based on the evaluation being accepted through the operation interface.

4. The information analysis system according to claim 3, wherein
the operations further comprises
calculating a first distance between the search information and the search result related to one of the search information, based on a number of times of a search executed in any one of the information sources during a period from execution of a search related to the search information to acquisition of the search result related to one of the search information, and
controlling whether to display the search result, based on the first distance related to the search result and the score related to the search result.

5. The information analysis system according to claim 4, wherein,
the operations further comprises
displaying the search result when the score related to one of the search results is greater than or equal to the first distance related to the search result.

6. The information analysis system according to claim 4, wherein
the operation interface is an interface for an input of the evaluation on the usefulness related to the search result, and,
the operations further comprises
based on the evaluation accepted through the operation interface, increasing the score related to the search result when the search result is evaluated to be useful, and decreasing the score related to the search result when the search result is evaluated to be not useful.

7. The information analysis system according to claim 4, wherein
the operation interface is an interface for an instruction to change a display state of the search result, and,
the operations further comprises
based on the instruction accepted through the operation interface, decreasing the score related to the search result when the instruction to set the displayed search result to non-display is given, and increasing the score related to the search result when the instruction to display the non-displayed search result is given.

8. The information analysis system according to claim 4, wherein
the operations further comprises
calculating a second distance between the search information and the search result, based on a number of times of searches executed on any one of the information sources until the search result is acquired,
when the score related to one of the search results is greater than or equal to the second distance related to the search result, repeatedly, by using the search result as the search information, acquiring the search result related to the search information from any one of the information sources, and,
when the score related to one of the search results is less than the second distance related to the search result, ending a search related to the search result.

9. The information analysis system according to claim 2, further comprising
the operations further comprises
determining whether a search related to the information source can be executed, based on limiting information indicating an execution condition for the search permissible to the information source, the limiting information being set with respect to the information source, and usage history information indicating an execution history of the search in the information source,
controlling whether to acquire the search result from the information source, based on a determination result in determining whether the search related to the information source can be executed, and
updating the usage history information when acquiring the search result from the information source.

10. The information analysis system according to claim 9, wherein
the limiting information at least includes time limit information being information indicating a period, and search count limit information being information indicating a number of times of executable searches related to the information source during the period,
the usage history information chronologically includes at least information by which a time when the search related to the information source is executed can be identified, and
the operations further comprises
acquiring, from the usage history information, the search executed in the information source in the period indicated by the time limit information, the period preceding a timing when executing the search in the information source, and when a count of the search is less than the count indicated by the search count limit information, determining that the search related to the information source can be executed.

11. The information analysis system according to claim 4, wherein
the operations further comprises
storing the score calculated with respect to the search result, and,
when the score is greater than or equal to the first distance related to the search result, displaying the search result.

12. The information analysis system according to claim 2, wherein,
the operations further comprises
inhibiting display of the search result being already displayed.

13. An information analysis method by an information processing system, the method comprising:
acquiring, by searching for search information related to a search target in any one of information sources, a search result related to the search information, and, by using the acquired search result as the search information, further acquiring a search result related to the search information from any one of the information sources again;
determining usefulness of the search result, based on an evaluation accepted with respect to the search result; and
controlling whether to display the search result, based on the usefulness related to the search result.

14. A non-transitory computer-readable recording medium embodying a program, the program causing a computer to perform a method, the method comprising:
acquiring, by searching for search information related to a search target in any one of information sources, a search result related to the search information, and, by using the acquired search result as the search information, further acquiring a search result related to the search information from any one of the information sources again;
determining usefulness of the search result, based on an evaluation accepted with respect to the search result; and
controlling whether to display the search result, based on the usefulness related to the search result.

15. (canceled)

16. (canceled)
